(19) United States
(12) Patent Application Publication
(10) Pub. No.: US 2018/0217743 A1
(43) Pub. Date: Aug. 2, 2018

(54) IMAGE PROCESSING APPARATUS, CONTROL METHOD, AND COMPUTER READABLE MEDIUM

(71) Applicant: CANON KABUSHIKI KAISHA, Tokyo (JP)

(72) Inventor: Tomoya Ishida, Yokohama-shi (JP)

(21) Appl. No.: 15/882,861

(22) Filed: Jan. 29, 2018

(30) Foreign Application Priority Data
Jan. 31, 2017 (JP) 2017-016204

(51) Int. Cl. G06F 3/0484; G06F 3/12

(52) U.S. Cl. CPC G06F 3/04847; G06T 1/00; G06F 3/1201

(57) ABSTRACT

A program in which the amount of change in at least one element, other than a position in a predetermined direction, between the state of a first knob stopping at a stopping position on a first slider and the state of the first knob that has moved a predetermined distance in the predetermined direction from the stopping position is different from the amount of change in the element between the state of a second knob stopping at a stopping position on a second slider and the state of the second knob that has moved the predetermined distance in the predetermined direction from the stopping position.

### BACKGROUND

### Field of the Disclosure

The present disclosure relates to an image processing apparatus, a control method, and a computer readable medium.

### Description of the Related Art

A slider is known as one of user interface controllers. A user moves a “knob”, which is provided on the slider, along the slider to enable a change in setting value corresponding to the slider to a value corresponding to the position of the moved knob.

PCT Japanese Translation Patent Publication No. 2015-518588 describes a slider for changing a property of an image according to the position of a knob. In terms of the slider described in PCT Japanese Translation Patent Publication No. 2015-518588, the knob is moved straight to the left or right to enable a change in setting value.

As many apparatuses using a slider are becoming widespread, it is being requested to improve usability for a user in the operation of moving a knob. For example, it is requested to increase the level of user satisfaction by causing a user to have positive feelings such as “fun” and “amusement” brought by moving the knob.

### SUMMARY

In order to solve the above-mentioned issue, an object of the present disclosure is to improve usability in the operation of moving a knob.

Hence, in order to achieve the above object, a program of the present disclosure is a predetermined application program causing a computer of an image processing apparatus that displays a first slider including a first knob, and a second slider substantially parallel to the first slider, the second slider including a second knob, on a display unit by using the predetermined application program to execute: moving the first knob along the first slider in accordance with a user's instruction; and moving the second knob along the second slider in accordance with the user's instruction, wherein a process based on at least one of a position of the first knob on the first slider and a position of the second knob on the second slider is executed, and the amount of change in at least one element, other than a position in a predetermined direction, between a state of the first knob stopping at a stopping position on the first slider and a state of the first knob that has moved a predetermined distance in the predetermined direction from the stopping position is different from the amount of change in the element between a state of the second knob stopping at a stopping position on the second slider and a state of the second knob that has moved the predetermined distance in the predetermined direction from the stopping position.

Further features of the present disclosure will become apparent from the following description of exemplary embodiments (with reference to the attached drawings).

### BRIEF DESCRIPTION OF THE DRAWINGS

FIG. 1 is a diagram illustrating the configuration of a print system, according to one or more embodiment(s) of the subject disclosure.

FIG. 2 is a block diagram illustrating the software configuration of an album creation application, according to one or more embodiment(s) of the subject disclosure.

FIG. 3 is a diagram of a setting screen displayed by the album creation application, according to one or more embodiment(s) of the subject disclosure.

FIGS. 4A and 4B are flowcharts illustrating an automatic layout process executed by the album creation application, according to one or more embodiment(s) of the subject disclosure.

FIG. 5 is a diagram illustrating a table that manages image analysis information of image data, according to one or more embodiment(s) of the subject disclosure.

FIGS. 6A to 6C are diagrams for explaining division of an image data group, according to one or more embodiment(s) of the subject disclosure.

FIG. 7 is a diagram for explaining classification of scenes, according to one or more embodiment(s) of the subject disclosure.

FIG. 8 is a diagram for explaining scoring of a main slot and a sub slot, according to one or more embodiment(s) of the subject disclosure.

FIGS. 9A to 91 are diagrams for explaining selection of image data, according to one or more embodiment(s) of the subject disclosure.

FIG. 10 is a diagram for explaining layout of image data, according to one or more embodiment(s) of the subject disclosure.

FIG. 11 is a diagram representing an example of the module configuration of software included in an image forming apparatus, according to one or more embodiment(s) of the subject disclosure.

FIG. 12 is a diagram illustrating a screen for selecting the design of an album to be created, according to one or more embodiment(s) of the subject disclosure.

FIG. 13 is a diagram illustrating an editing screen for editing layout information, according to one or more embodiment(s) of the subject disclosure.

FIG. 14 is a diagram illustrating a screen for adjusting the frequency of occurrence of each object in the edited album, according to one or more embodiment(s) of the subject disclosure.

FIGS. 15(A) to 15(C) are diagrams for explaining the operation of changing a setting value related to objects of “people”, according to one or more embodiment(s) of the subject disclosure.

FIGS. 16(A) to 16(C) are diagrams for explaining the operation of changing a setting value related to objects of “animals”, according to one or more embodiment(s) of the subject disclosure.

FIGS. 17(A) to 17(C) are diagrams for explaining the operation of changing the setting value related to objects of “animals” from an intermediate value to a minimum value, according to one or more embodiment(s) of the subject disclosure.

FIG. 18 is a flowchart illustrating a process that is executed by an image processing apparatus when an album editing screen is displayed, according to one or more embodiment(s) of the subject disclosure.

FIG. 19 is a diagram illustrating layout images of a certain double-page spread of the edited album based on the setting values, according to one or more embodiment(s) of the subject disclosure.

FIG. 20 is a diagram explaining the configuration of an image selection unit in more detail, according to one or more embodiment(s) of the subject disclosure.

FIGS. 21A and 21B are flowcharts illustrating the details of an image selection process, according to one or more embodiment(s) of the subject disclosure.

FIG. 22 is a block diagram explaining the configuration of hardware of the image processing apparatus, according to one or more embodiment(s) of the subject disclosure.

### DESCRIPTION OF THE EMBODIMENTS

Preferred embodiments of the present disclosure are described in detail hereinafter with reference to the accompanying drawings. The following embodiments do not limit the present disclosure according to the scope of claims. Moreover, all combinations of features described in the embodiments are not necessarily required by the solving means of the present disclosure.

In the following embodiments, a description is given of a procedure for operating an application program for creating an album (hereinafter also referred to as the “album creation app”) on an image processing apparatus, and generating layout automatically. Unless otherwise specified, images described below include still images, video, frame images in the video, and still images, video, and frame images in the video on a social networking service (SNS) server.

### First Embodiment

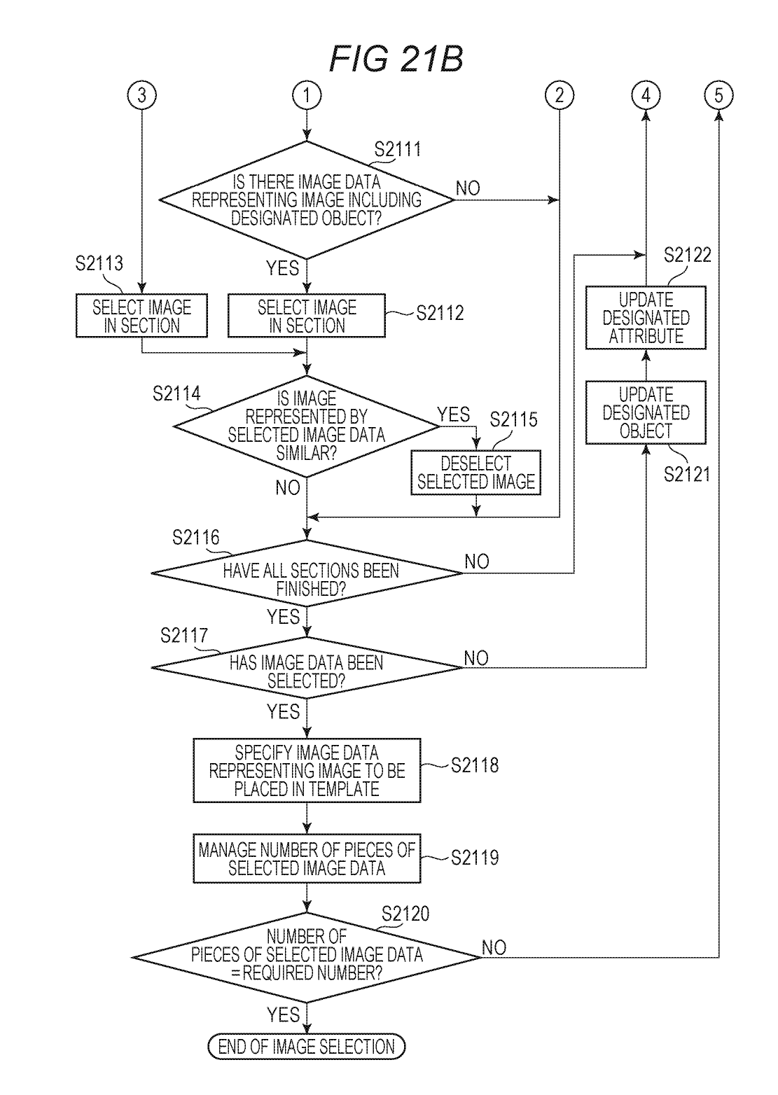

FIG. 22 is a block diagram explaining the configuration of hardware of an image processing apparatus 100 according to the present disclosure. Examples of the image processing apparatus include a personal computer (PC), a smartphone, a tablet terminal, a camera, and a printer. In the embodiment, the image processing apparatus is assumed to be a PC.

In FIG. 22, the image processing apparatus 100 includes a CPU 101, a ROM 102, a RAM 103, an HDD 104, a display 105, and a keyboard 106, a mouse 107, and a data communication unit 108. They are connected by a data bus 109 to each other.

The central processing unit (CPU/processor) 101 is a system control unit, and controls the entire image processing apparatus 100. Moreover, the CPU 101 executes an image processing method described in the embodiment in accordance with a program. The number of CPUs is one in FIG. 22, but is not limited to one. A plurality of CPUs may be provided.

A program executed by the CPU 101 and an operating system (OS) are stored in the ROM 102. The RAM 103 provides memory where various pieces of information are temporarily stored upon the CPU 101 executing the program. The hard disk (HDD) 104 is a storage medium for storing, for example, an image file and a database that retains (stores) a result of a process such as image analysis. In the embodiment, the album creation app described below is stored in the RAM 103.

The display 105 (a display unit) is a device that presents a user with a user interface (UI) of the embodiment and an image layout result. The display 105 may have a touch sensor function. The keyboard 106 is one of input devices, and is used, for example, to input predetermined information on the UI displayed on the display 105. The predetermined information is information on, for example, the numbers of double-page spreads and pages of an album that is desired to be created. The mouse 107 is one of input devices, and is used, for example, to click a button on the UI displayed on the display 105. For example, the user double-clicks an icon displayed on the display 105, the icon corresponding to the album creation app, by operating the mouse 107 to start the album creation app.

The data communication unit 108 (a communication unit) is a device for communicating with external devices such as a printer and a server. For example, data created by the album creation app is transmitted via the data communication unit 108 to an unillustrated printer or server connected to the image processing apparatus 100. Moreover, the data communication unit 108 receives still image data on an unillustrated server or SNS (social networking service) server. In the embodiment, the data communication unit 108 receives still image data from the SNS server, but may receive video data.

The data bus 109 connects the above-mentioned units (102 to 108) and the CPU 101.

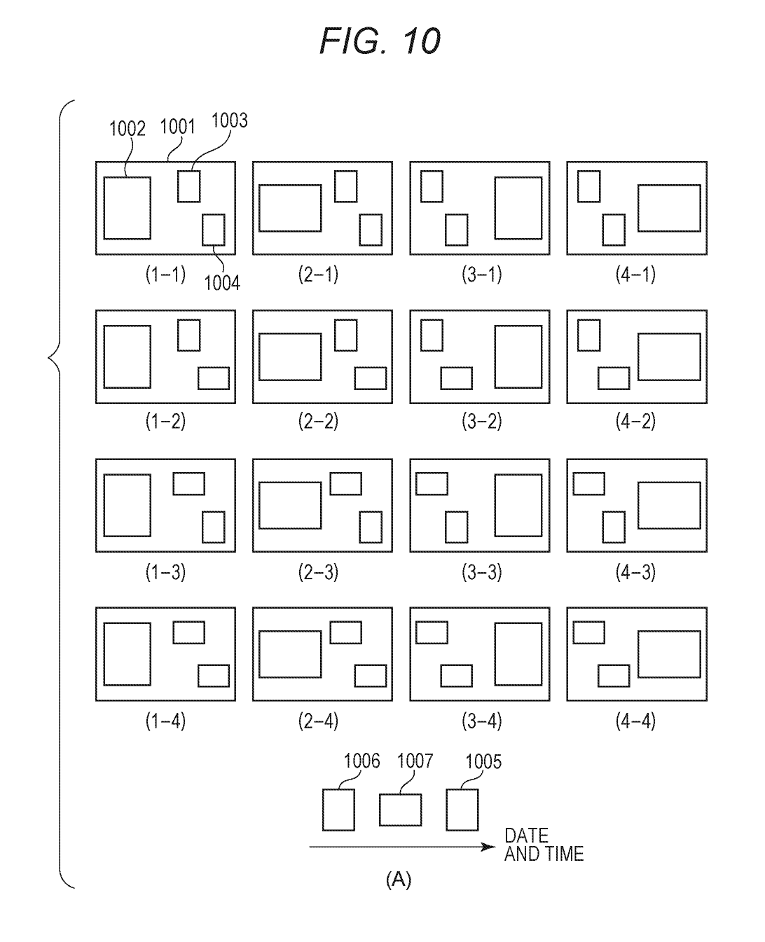

FIG. 11 is a diagram representing an example of the module configuration of software included in the image processing apparatus 100. In FIG. 11, a module 92 is an Ethernet control stack that controls Ethernet. A module 91 is an IP network control stack that controls an IP network. A module 90 is a WSD control stack that controls Web Service on Devices (WSD) that provides a mechanism for searching for a device on a network. A module 88 is a PnP-X control stack that controls plug and play of the network. PnP-X is an abbreviation of Plug and Play Extensions being a standard function of an OS of Windows 8 (registered trademark) as a series of extension functions of Plug and Play, Plug and Play Extensions providing a support for a network connection device. A module 85 is a device driver group, and is configured including a standard driver group 87 that comes standard in the OS, and a driver group 86 made by an independent hardware vendor (IHV) provided from the IHV.

A module 84 is an application/DDI interface, and is configured including an application programming interface (API), and a device driver interface (DDI). A module 80 is, for example, a photo album creation application. A module 143 is, for example, a web browser application. A module 82 is an application group, and is configured including, for example, the modules 80 and 143.

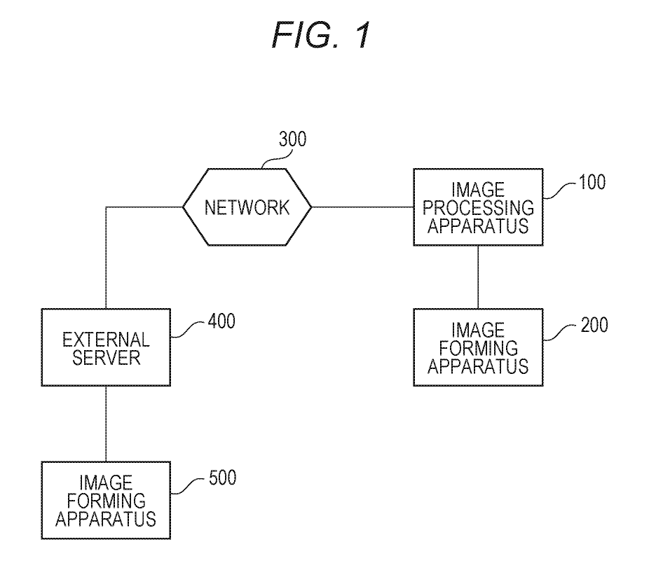

FIG. 1 is a diagram illustrating a print system of the embodiment. The print system is assumed to include an image forming apparatus 200, a network 300, an external server 400, and an image forming apparatus 500 in addition to the image processing apparatus 100.

The image forming apparatus 200 executes an image forming process (print process) that forms an image on a recording medium with a recording material on the basis of a print job accepted from the image processing apparatus 100 or the like. In the embodiment, a mode is described in which the image processing apparatus 100 transmits (outputs) generated layout information to the external server. It may be, for example, a mode in which the image processing apparatus 100 transmits the generated layout information as a print job to the image forming apparatus 200. In this case, an album based on the layout information is created by the image forming apparatus 200.

The network 300 is connected to the image processing apparatus 100 and the external server 400, and is a communication network for conveying information between them. The network 300 may be a wired network or a wireless network.

The external server 400 accepts layout information described below from the image processing apparatus 100 via the network 300. In other words, the external server 400 is a server that is responsible for the receipt of orders and management of an album. When a user who operates the image processing apparatus 100 has gone through the procedure of purchasing an album, the external server 400 causes the image forming apparatus 500 to create an album based on the accepted layout information through the image forming process. The album created by the image forming apparatus 500 is then delivered to the user who went through the procedure of purchasing the album.

<Automatic Layout of an Album>

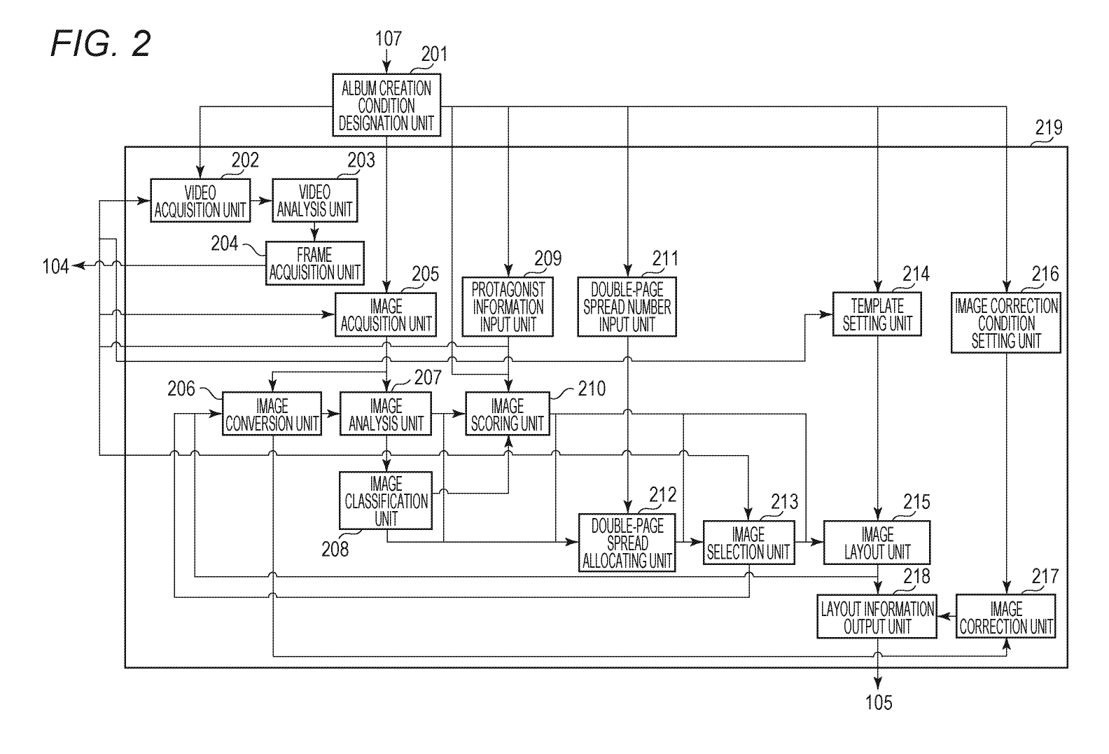

FIG. 2 is a software block diagram of an application program for creating an album (hereinafter the album creation app) of the embodiment. In the embodiment, the user operates the mouse 107 and double-clicks an icon displayed on the display 105, the icon corresponding to the album creation app saved in the HDD 104, to start the album creation app. Moreover, the album creation app is, for example, installed from an external server via the data communication unit 108 to be saved in the HDD 104.

The album creation app has various functions. However, especially an automatic layout function provided by an automatic layout processing unit 219 is described here. The automatic layout function is a function for creating a layout image being an image where images represented by image data acquired by classifying and selecting still images and video on the basis of their contents and attributes are placed in a template prepared in advance, and by extension a function for generating layout information for representing a layout image. The user executes an album ordering process to output the layout image displayed in this manner as the album.

As illustrated in FIG. 2, the album creation app includes an album creation condition designation unit 201 and an automatic layout processing unit 219.

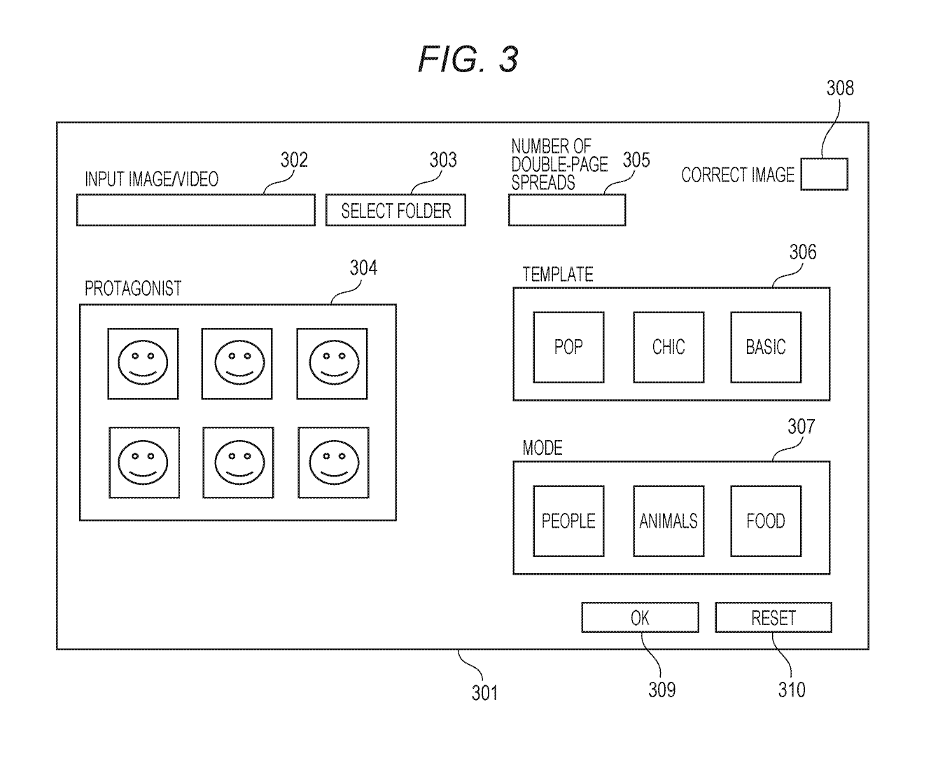

The album creation condition designation unit 201 accepts the designation of album creation conditions in accordance with the operation of an UI described below with, for example, the mouse 107, and outputs the album creation conditions to the automatic layout processing unit 219. The designated conditions include the designation of, for example, IDs of image data targeted to be processed and protagonists, the number of double-page spreads of the album, template information, an on/off condition of image correction, an on/off condition of video use, and the mode of the album. A double-page spread corresponds to a pair of pages adjacent to each other, which is printed on different sheets (or pages). Moreover, it is assumed in the album creation app of the embodiment that the layout of one double-page spread is created on one display window. The album creation condition designation unit 201 displays such a setting screen as illustrated in FIG. 3, accepts input on the screen, and accordingly accepts the designation of the album creation conditions.

A video acquisition unit 202 acquires a video group (video data group) designated by the album creation condition designation unit 201 from a storage area such as the HDD 104.

A video analysis unit 203 analyzes video data acquired by the video acquisition unit 202. The video analysis unit 203 extracts at predetermined intervals frames cut from the video data and managed in chronological order, and targets them for analysis. The video analysis unit 203 can determine which frame in the video is a good image by analysis processes such as object detection, size specification, smile determination, shut eye determination, blur and out-of-focus determination, and brightness determination.

A frame acquisition unit 204 cuts a frame from the video on the basis of a result (assessment) analyzed by the video analysis unit 203, and saves the cut frame as image data in the HDD 104.

An image acquisition unit 205 acquires an image group (image data group) designated by the album creation condition designation unit 201 from a storage area such as the HDD 104. The image acquisition unit 205 may acquire the image group from a storage area such as a server on the network, an SNS server, or the like via the data communication unit 108. The image group here indicates candidates for image data used to create an album. For example, January 1, XXXX to December 31, XXXX may be designated as a condition related to the date and time when image data targeted for layout was generated (pictures corresponding to the image data were taken) (hereinafter referred to as the photographing date and time) by the album creation condition designation unit 201. In this case, the image acquisition unit 205 acquires all image data generated from January 1, XXXX to December 31, XXXX as an image group.

The image data saved in the storage area is, for example, still image data, and cut image data acquired by cutting a frame from video data. The still image data and the cut image data are acquired from an imaging device. The imaging device may be included in the image processing apparatus 100, or included in an external apparatus (such as a PC, a smartphone, a digital camera, or a tablet terminal) being an apparatus outside the image processing apparatus 100. The image processing apparatus 100 acquires image data via the data communication unit 108 when acquiring the image data from the external apparatus. Moreover, the image processing apparatus 100 may acquire still image data and cut image data from a network or server via the data communication unit 108. The CPU 101 analyzes data associated with the image data and determines from where each piece of the image data has been acquired.

An image conversion unit 206 converts pixel count information and color information of the image data acquired by the image acquisition unit 205. The contents of pixel count information and color information of image data are determined in advance to cause the image conversion unit 206 to perform a conversion. The information is saved in the album creation app or a parameter file used by the album creation app. In the embodiment, the image data acquired by the image acquisition unit 205 is converted into image data whose pixel count is 420 pixels on a short side, and color information is sRGB.

An image analysis unit 207 performs the analysis processes on the image data. In the embodiment, the image analysis unit 207 performs the analysis processes on the image data converted by the image conversion unit 206. Specifically, features are acquired from the converted image data, and object detection, face detection, the recognition of an expression on the detected face, and individual recognition of the detected face are executed on the converted image data. Furthermore, photographing date and time information is acquired from data (for example, Exif information) associated with the pre-conversion image data acquired by the image acquisition unit 205. The photographing date and time information is not limited to acquisition from the Exif information, and information on the date and time when image data is created or updated may be used as the photographing date and time information. Moreover, information on the date and time when image data is uploaded to a local server or SNS server, or image data is downloaded from the local server or SNS server may be used. These pieces of date and time information are also handled below as the photographing date and time information. The local server is assumed to be a storage area included in the image processing apparatus 100, for example, the HDD 104.

An image classification unit 208 makes a scene division and a scene classification, which are described below, on the image data group, using the photographing date and time information, the number of images, and the object detection result information such as the information on the detected face. Scenes are photographing scenes such as “trip”, “daily life”, and “wedding”. It can also be said that a scene is, for example, a collection of image data generated at a photographing opportunity of a certain period.

A protagonist information input unit 209 inputs, into an image scoring unit 210, an identification information (ID) of the protagonist designated by the album creation condition designation unit 201.

The image scoring unit 210 scores each piece of the image data in such a manner that image data suitable to be laid out obtains a high score. Scoring is executed in accordance with the information obtained by the image analysis unit 207 and the information obtained by the image classification unit 208. Moreover, other information may be used additionally or alternatively. In the embodiment, the image scoring unit 210 scores each piece of the image data in such a manner that image data including the protagonist ID input from the protagonist information input unit 209 scores high.

A double-page spread count input unit 211 inputs, into a double-page spread allocating unit 212, the number of double-page spreads of the album designated by the album creation condition designation unit 201.

The double-page spread allocating unit 212 divides (groups) an image group, and allocates them to double-page spreads. The double-page spread allocating unit 212 divides the image group into the input number of double-page spreads and allocates part of the image group to each double-page spread.

An image selection unit 213 selects image data on the basis of the scores given by the image scoring unit 210 from the image group allocated by the double-page spread allocating unit 212 to the double-page spreads.

A template setting unit 214 reads, from the HDD 104, a plurality of templates corresponding to the template information designated by the album creation condition designation unit 201, and inputs the plurality of templates into an image layout unit 215. In the embodiment, the plurality of templates is assumed to be held in the album creation app saved in the HDD 104. Moreover, the plurality of templates includes, for example, information on the size of the entire template, and information on the number, sizes, and positions of slots included in the template.

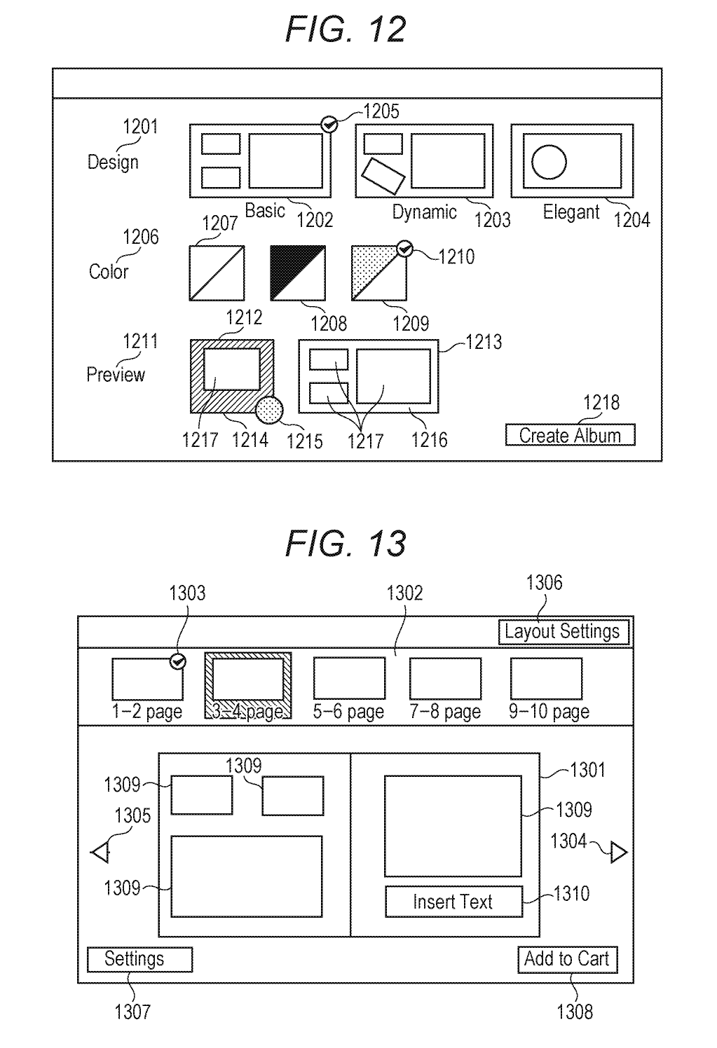

The image layout unit 215 determines the layout of a double-page spread. Specifically, the image layout unit 215 selects a template suitable for the image data selected by the image selection unit 213 from the plurality of templates input by the template setting unit 214, and determines the placement position of each image. Consequently, the layout of a double-page spread is determined. The image data output from a layout information output unit 218 is displayed in such a form as illustrated in FIG. 13 on the display 105.

The layout information output unit 218 outputs layout information for displaying a layout image on the display 105, in accordance with the layout determined by the image layout unit 215. The layout image is, for example, an image where images represented by the image data selected by the image selection unit 213 are placed in the selected template. The layout information is bitmap data representing the image.

An image correction unit 217 executes correction processes such as dodging correction (brightness correction), red-eye correction, and contrast correction. A correction condition input unit 216 inputs, into the image correction unit 217, the on/off condition of image correction designated by the album creation condition designation unit 201.

When the album creation app according to the embodiment is installed in the image processing apparatus 100, the OS operating on the image processing apparatus 100 generates a start icon on a top screen (desktop) displayed on the display 105. When the user double-clicks the start icon by operating the mouse 107, a program of the album creation app saved in the HDD 104 is loaded into the RAM 103. The CPU 101 executes the program loaded in the RAM 103 to start the album creation application.

FIG. 3 is a diagram illustrating an example of a UI configuration screen 301 provided by the started album creation app. The UI configuration screen 301 is displayed on the display 105. The user sets album creation conditions described below via the UI configuration screen 301. Accordingly, the album creation condition designation unit 201 acquires setting contents designated by the user. A path box 302 on the UI configuration screen 301 indicates a save location (path), in the HDD 104, of an image/video group targeted to create an album. The user clicks a folder selection button 303 by operating the mouse 107, which allows the user to selectably display a folder including the image/video group targeted to create the album in a tree configuration. A folder path including the image/video group selected by the user is then displayed in the path box 302.

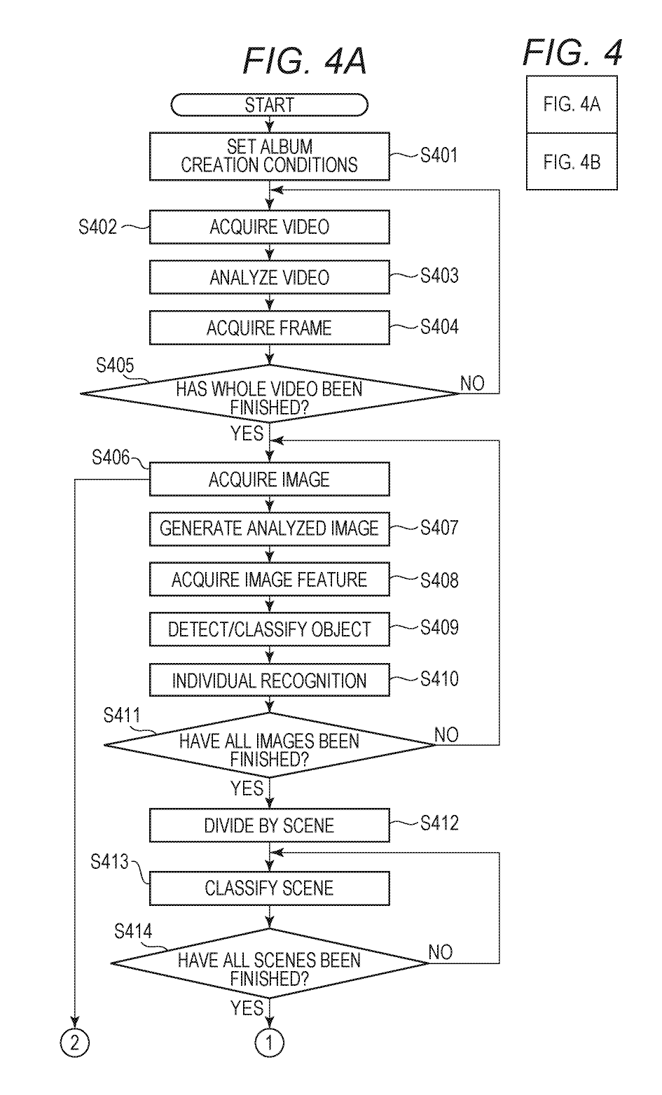

A protagonist designation icon 304 is an icon for the user to designate the protagonist, and a person's face image is displayed as an icon. A person corresponding to an icon selected by the user's operation is set as the protagonist of the album targeted to be created. Moreover, the protagonist designation icon 304 is used to specify the protagonist being a main figure among people showing on images represented by the image data targeted for analysis. The protagonist designation icon 304 is, for example, a face image of a person selected by the user, or a face image of a person determined by a method described below, among face images of people registered in a face database. The protagonist can also be set automatically in a procedure illustrated in FIGS. 4A and 4B.

A double-page spread count box 305 accepts the setting of the number of double-page spreads of the album from the user. The user inputs a numeric character directly into the double-page spread count box 305 via the keyboard 106, or inputs a numeric character into the double-page spread count box from a list by using the mouse 107.

A template designation icon 306 displays illustration images according to the (for example, pop and chic) tastes of the templates. The template corresponding to the icon selected by the operation of the user is set as a template used for the album targeted to be created. In the embodiment, a template has image placement frames (slots) for placing image data. The image data is buried in the slots of the template to complete one layout image.

A mode designation unit 307 is an icon corresponding to the mode of an album targeted to be created. The mode of an album is a mode for giving a high priority to images including predetermined objects and laying out the images in a template. Objects corresponding to each mode are placed in a higher proportion in an album of the mode. In the embodiment, there are three modes: “people”, “animals”, and “food”. The mode of an album can translate into, for example, the theme of an album. If, for example, “animals” is selected as the mode of the album, an image including an animal is preferentially laid out in a template. There may be a mode for preferentially laying out in a template image data representing an image where an object other than those in the above-mentioned three modes is shown. Moreover, a plurality of modes may be selected at the same time. In this case, an image including at least one of a plurality of objects corresponding to the selected plurality of modes is preferentially laid out in a template. The mode corresponding to the selected icon is set as the mode of the album targeted to be created.

The number of modes of an album is not limited to the above-mentioned three. There may be other modes such as “buildings”, “transport”, and “flowers”.

A checkbox 308 accepts the setting of on/off of image correction from the user. An OK button 309 is a button for accepting the completion of the settings from the user. When the user presses the OK button 309, the album creation condition designation unit 201 outputs each piece of the setting information set on the screen 301 to a module corresponding to the piece of the setting information in the automatic layout processing unit 219.

A reset button 310 is a button for resetting each piece of the setting information on the UI configuration screen 301.

Settings other than the above-mentioned settings can be established on the UI configuration screen 301. For example, a setting related to video and a setting of an acquisition destination of image/video data may be able to be established.

A server name box indicates a server name or SNS name including an image group used to create an album. When a login to a designated server or SNS is completed by the operation of the user via a login screen, the CPU 101 can acquire image data from the designated server or SNS.

A video use checkbox accepts, from the user, a setting as to whether or not the folder designated in the path box 302 or video on the designated server or SNS in the server name box is used to create the album.

A target period box accepts, from the user, a setting of a condition of a photographing date and time period of an image group or video group targeted to create an album.

The screen illustrated in FIG. 3 may include, for example, an area representing a rendering of an album represented by layout information generated on the basis of input settings.

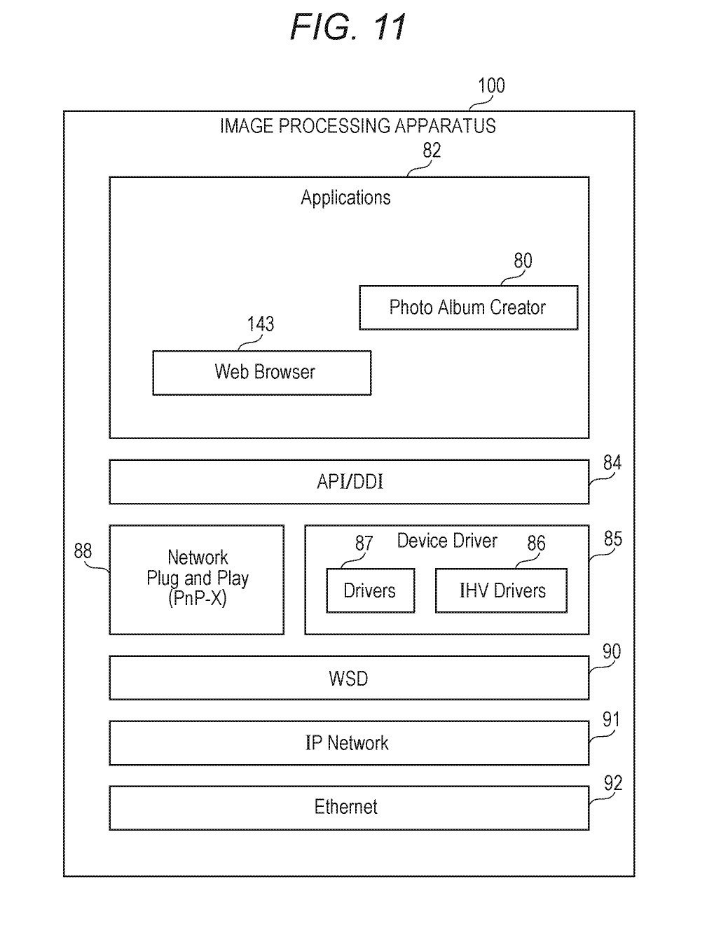

Moreover, for example, not only such a screen as illustrated in FIG. 3 but also such a screen as illustrated in FIG. 12 may be displayed as a setting input screen for the automatic layout process. FIG. 12 is a screen for selecting the design of an album to be created.

The design selection screen illustrated in FIG. 12 includes a design selection area 1201, a color selection area 1206, and a preview area 1211.

Three options, an option 1202 for selecting a “Basic” type, an option 1203 for selecting a “Dynamic” type, and an option 1204 for selecting an “Elegant” type, are displayed in the design selection area 1201. A check mark 1205 is placed by the option that is currently being selected.

An option 1207 for making the cover “white” and the body “white”, an option 1208 for making the cover “black” and the body “white”, and an option 1209 for making the cover “texture” and the body “white” are displayed in the color selection area 1206. A check mark 1210 is placed by the option that is currently being selected. The options 1207, 1208, and 1209 are called color chips here. The color chip includes a triangle on the upper left side and a triangle on the lower right side. The triangle on the upper left side indicates the color or texture of the cover. The triangle on the lower right side indicates the color or texture of the body. In this manner, one color chip expresses the colors or textures of the cover and the body.

The preview area 1211 indicates how the setting items selected in the design selection area 1201 and the color selection area 1206 are reflected in the finished album. A cover image 1212 is a rendering of the cover. A body image 1213 is a rendering of the body. Slots 1217 for placing an image are present in the cover image 1212 and the body image 1213, respectively.

Here, the color chip selected in the color selection area 1206 is the option 1209. Accordingly, a background 1214 of the cover image 1212 is expressed in texture, and a background 1216 of the body image 1213 is expressed in white. Moreover, a magnifier 1215 is attached to the cover image 1212. An image where part of the cover image 1212 is enlarged is displayed on the magnifier 1215.

Here, the design selected in the design selection area 1201 is the option 1202, and the color chip selected in the color selection area 1206 is the option 1209. Hence, the background 1216 of the body image 1213 is expressed in white. The “Basic” type is selected for the placement and shapes of the slots 1217.

When a “Create Album” button 1218 is selected, an analysis of image data is started by the automatic layout function. The generation of layout information is started on the basis of the settings input on the screens illustrated in FIGS. 3 and 12.

FIGS. 4A and 4B are flowcharts illustrating the automatic layout process executed by the album creation app according to the embodiment. The flowcharts illustrated in FIGS. 4A and 4B are achieved by, for example, the CPU 101 reading the program corresponding to the album creation app stored in the HDD 104 to the ROM 102 or the RAM 103 and executing the program. The automatic layout process is described with reference to FIGS. 4A and 4B. As illustrated below, when an album is created in the embodiment, an image group for creating the album is divided according to the photographing times, and an image to be placed in a page is selected from each sub image group obtained by the division. Moreover, the flowcharts illustrated in FIGS. 4A and 4B are started, for example, when the “Create Album” button 1218 is selected.

Firstly, in S401, the CPU 101 sets the album creation conditions. Specifically, for example, the CPU 101 accepts settings of the album creation conditions from a user via the screens illustrated in FIGS. 3 and 12.

In S402, the CPU 101 causes the video acquisition unit 202 to acquire video data included in a storage area being a search target.

In S403, the CPU 101 causes the video analysis unit 203 to analyze the video data acquired in S402.

In S404, the CPU 101 causes the frame acquisition unit 204 to cut a frame from the video data analyzed in S403, and save the cut frame as image data in the HDD 104.

In S405, the CPU 101 determines whether or not the process of S402 to S404 has been finished for the whole video data included in the storage area being the search target. If the process has not been finished (No in S405), execution returns to S402. Video data that has not yet become a target of the process is acquired. If the process has been finished (Yes in S405), execution proceeds to S406.

In S406, the CPU 101 causes the image acquisition unit 205 to acquire image data included in the storage area being the search target.

In S407, the CPU 101 causes the image conversion unit 206 to perform a conversion on the image data.

In S408, the CPU 101 causes the image analysis unit 207 to acquire a feature from the image data converted in S407. An example of the feature is focus.

In S409, the CPU 101 causes the image analysis unit 207 to execute an object detection process on the image data converted in S407. Firstly, the CPU 101 detects the face of a person from an image represented by the image data converted in S407. Moreover, the CPU 101 extracts an image of the face, and acquires an upper left coordinate value and a lower right coordinate value of the position of the image of the detected face. The two types of coordinates are held to allow the CPU 101 to acquire the position and size of the face image. The CPU 101 executes the face detection process, using AdaBoost to also enable the acquisition of information on the reliability of the detected object. The details of the reliability are described below. Moreover, in S409, the CPU 101 may create a strong discriminator by AdaBoost with objects of not only faces but also, for example, animals such as dogs and cats, flowers, food, buildings, ornaments, and transport as detection targets. Consequently, the CPU 101 also enables the detection of objects other than faces. In the embodiment, in S409, the CPU 101 executes not only the process of detecting faces but also the process of detecting animals and food.

In S410, the CPU 101 causes the image analysis unit 207 to execute an individual recognition process. The CPU 101 specifies a person corresponding to a representative face image having a higher similarity than a threshold and also the highest similarity, as a person corresponding to the face image extracted in S409. When the similarities between the face image extracted in S409 and all representative face images saved in a face dictionary database are less than the threshold, the CPU 101 assigns a new individual ID to the extracted face image to register it as a new person in the face dictionary database.

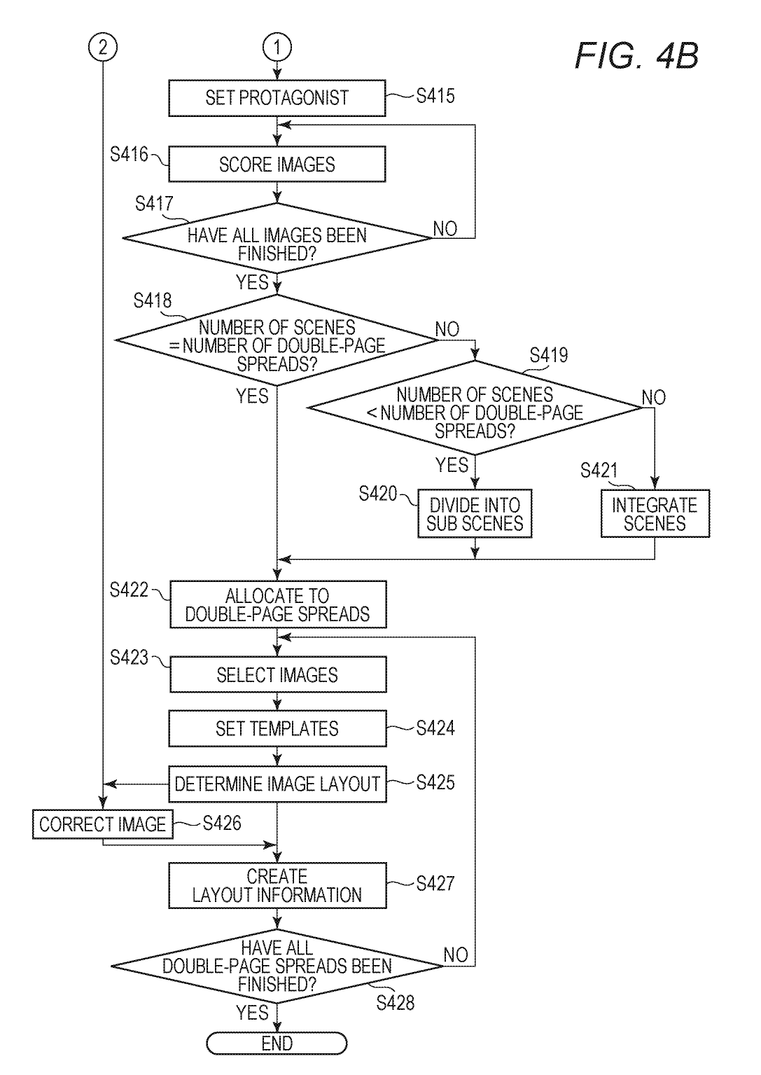

Image analysis information 500 on each piece of the image data acquired in S408 to S410 is tied to an image ID 501 for identifying the piece of the image data, and is stored in a storage area such as the RAM 103 or the HDD 104. As illustrated in FIG. 5, for example, photographing date and time information 502 and a focus determination result 504, which were acquired in S408, and a face image count 506 and position information 507, which were detected in S409, are stored in table form.

An image attribute 503 indicates the attribute of each piece of the image data. For example, image data being still image data acquired from a local server has a “still image” attribute. Moreover, for example, image data cut from video data acquired from the local server and saved has a “video” attribute. Moreover, for example, image data acquired from an SNS server has an “SNS” attribute.

Object classification 505 indicates the category (type) of an object included in an image represented by each piece of the image data, and the reliability of the category.

It is assumed in the embodiment that objects in three categories (types), “people”, “animals”, and “food”, are detected, and that information indicating the category of an object detected in an image represented by each piece of the image data is stored in the object classification 505. In other words, the object classification 505 is information indicating into which category an object included in an image represented by each piece of image data falls. The information may be managed by, for example, a flag. Moreover, as described above, objects detected are not limited to the three categories of “people”, “animals”, and “food”. Accordingly, information indicating categories of, for example, “flowers”, “buildings”, “ornaments”, and “transport” may be stored in the object classification 505.

The reliability of the category is information indicating a highly possible category into which an object included in an image represented by image data falls. As the reliability of the category is increased, the category is more likely to be a category of the object included in the image represented by the image data.

In S411, the CPU 101 determines whether or not the process of S407 to S410 has been finished for the whole image data included in the storage area being the search target.

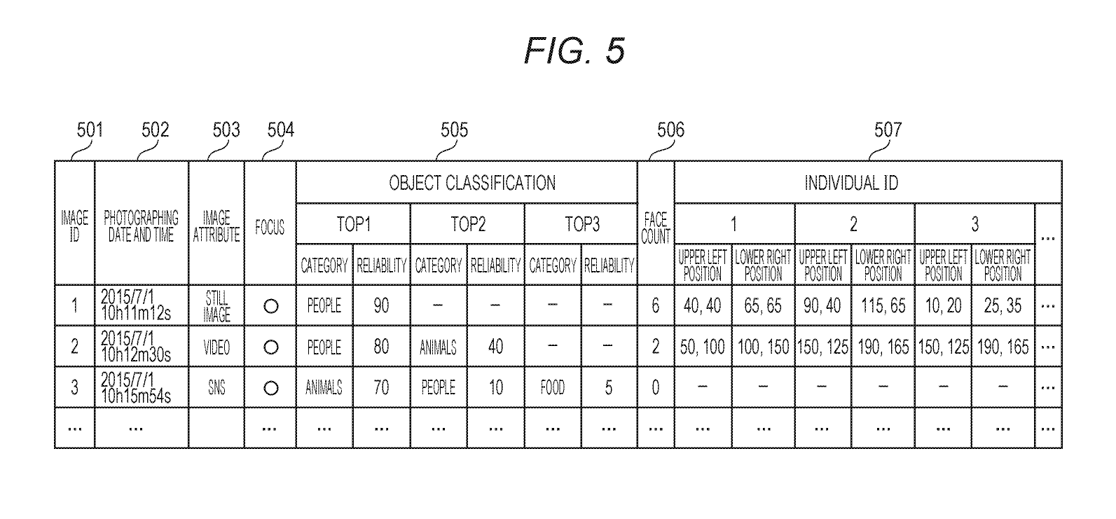

In S412, the CPU 101 causes the image classification unit 208 to make a scene division. The scene division indicates that the whole image data obtained in S401 to S411 is divided according to the scenes, and managed as a plurality of image groups. In the following description, each image group obtained by dividing the whole image data (a main image group) is referred to as the sub image group. An example of grouping of photographed image data is illustrated in FIG. 6A. In FIGS. 6A to 6C, the horizontal axis indicates the photographing date and time (which becomes older toward the left and newer toward the right), and the vertical axis indicates the number of pieces of photographed image data. In FIG. 6A, a photographed image data group is divided into eight sub image groups (groups) of groups 601 to 608. In FIG. 6A, arrows indicate boundaries between groups.

In S413, the CPU 101 causes the image classification unit 208 to make a scene classification. Specifically, the CPU 101 scores the sub image groups obtained by the scene division in S412, according to the types of scenes. The sub image groups are classified into the type of scene scored the highest. In the following description, scoring in S413 is called scene classification and scoring. It is assumed in the embodiment that the types of scenes include “trip”, “daily life”, and “ceremony”. A sub image group is classified into any of the scenes. A scene classification table where information on a feature corresponding to each type of scene is stored is used for the scene classification and scoring.

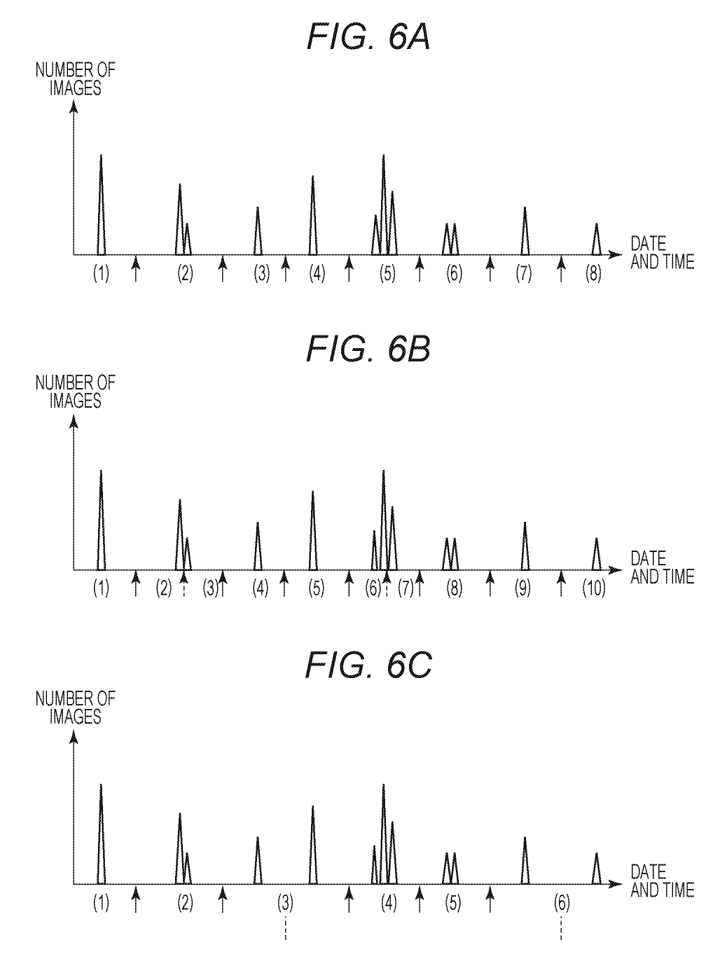

In the embodiment, a table 700 illustrated in FIG. 7 is assumed to be used as the scene classification table. In the table 700, averages and standard deviations of a photographing period 702, a photographed image count 703, and a photographed person count 704 are registered, associated with a scene ID 701.

In S414, the CPU 101 determines whether or not the scene classification in S413 has been finished for all the sub image groups acquired in S412. If the scene classification has not been finished (No in S414), execution returns to S413. The scene classification is performed on a sub image group that has not yet been targeted for the scene classification.

In S415, the CPU 101 causes the image scoring unit 210 to set the protagonist. The protagonist is set for an image group designated by the user, in one of two types of setting methods, automatic and manual.

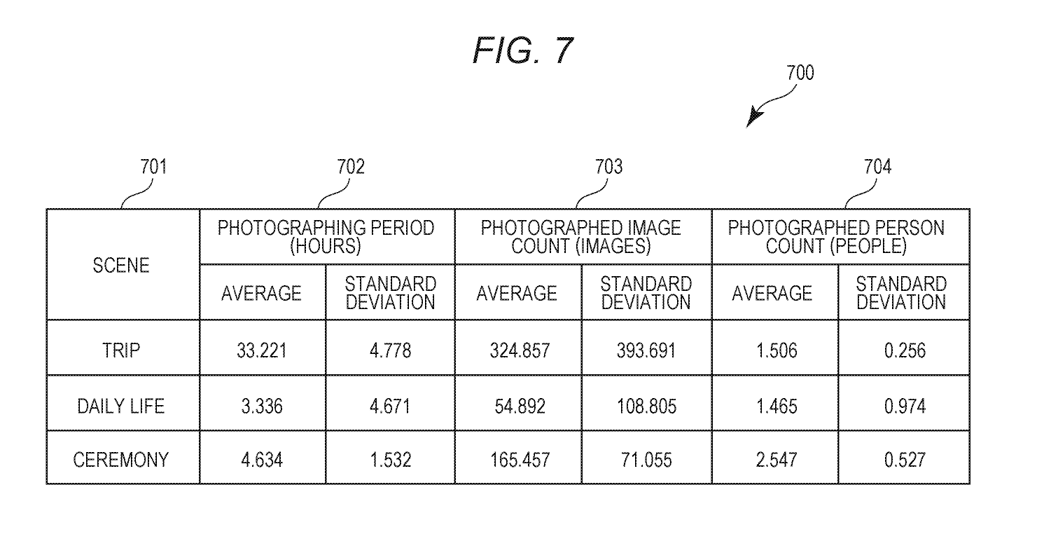

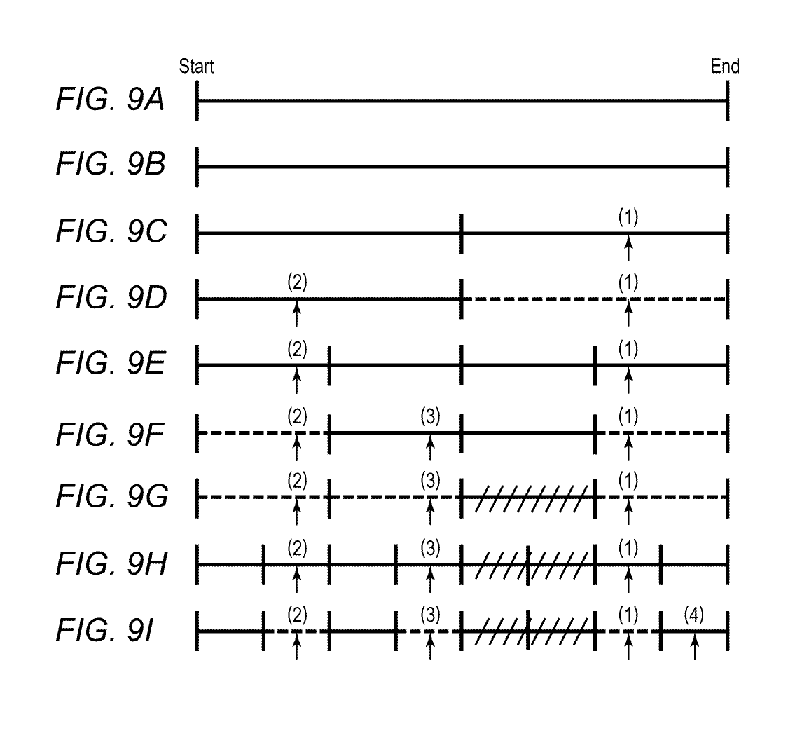

In S416, the CPU 101 causes the image scoring unit 210 to score the images. The image scoring in S416 is to add a score assessed from the point of view described below (scoring), according to the image data. The score is referred to when image data representing an image to be placed in a template is selected, which is described below. The scoring method is described here, using FIGS. 8 and 10.

FIG. 10 illustrates a template group used for layout of image data. Each of a plurality of templates included in the template group corresponds to each double-page spread. A template 1001 is one template. A main slot 1002 is a main slot. Sub slots 1003 and 1004 are sub slots. The main slot 1002 is a slot (a frame where an image is laid out (placed)) of the main in the template 1001, and is larger in size than the sub slots 1003 and 1004. In S416, the CPU 101 performs, as the image scoring process, the process of adding, to image data, both of a score for the main slot and a score for the sub slot, which correspond to a scene of a type to which the image data belongs.

In the image scoring, a slot feature table where information on features of images that are to be adopted for the main slot and the sub slot is stored according to the types of scenes is used. Consequently, scoring for both of the main slot and the sub slot is executed on image data. Furthermore, in the embodiment, the CPU 101 adds points to the score calculated as described above on the basis of the mode designated by the album creation condition designation unit 201.

The CPU 101 performs the image scoring on each piece of image data of the image data group designated by the user. The score added by the image scoring becomes a selection criterion in an image selection process in S423 below. Consequently, the CPU 101 can give a higher priority to image data representing an image including an object of a category corresponding to the mode of an album than image data representing an image without the object and select the image data in the image selection process described below.

FIG. 8 illustrates an example of the score result obtained by layout scoring. For example, 20 points are assigned to an image ID 1 for the main slot. 45 points are assigned to an image ID 2 for the main slot. That is to say, this indicates that the image ID 2 is closer to the user's judgment criterion for the main slot.

In S417, the CPU 101 determines whether or not the image scoring in S416 has been finished for the whole image data acquired by the image acquisition unit 205. If the image scoring has not been finished (No in S417), execution returns to S416. The image scoring is executed on image data that has not yet been targeted to be processed.

In S418, the CPU 101 determines whether or not the number of scenes (the number of sub image groups) obtained by the scene division in S412 is the same as the number of double-page spreads input by the double-page spread count input unit 211 (the number of double-page spreads input into the double-page spread count box 305).

In S419, the CPU 101 causes the double-page spread allocating unit 212 to determine whether or not the number of scenes obtained by the scene division in S412 is smaller than the number of double-page spreads input by the double-page spread count input unit 211.

In S420, the CPU 101 causes the double-page spread allocating unit 212 to make a sub scene division. The sub scene division indicates further dividing the scenes obtained by the scene division if the number of divided scenes<the number of double-page spreads.

In S421, the CPU 101 causes the double-page spread allocating unit 212 to integrate the scenes. The scene integration indicates the integration of the divided scenes (sub image groups) if the number of divided scenes>the number of double-page spreads of the album. Specifically, the CPU 101 integrates the scenes in such a manner that the number of scenes agrees with the number of double-page spreads. A description is given here taking, as an example, a case where the number of divided scenes is eight as in FIG. 6A, and the designated number of double-page spreads is six. FIG. 6C illustrates a result obtained by the scene integration in FIG. 6A. Scenes before and after broken-line points are integrated to have six divisions.

In S422, the CPU 101 causes the double-page spread allocating unit 212 to perform allocation to double-page spreads. The number of sub-image groups and the designated number of double-page spreads are made the same by S418 to S421. In the embodiment, a sub image group whose photographing date and time is at the top is allocated first to the first double-page spread. In other words, a sub image group is allocated to a page(s) of each double-page spread of an album in photographing date and time order. Consequently, it is possible to create an album where sub image groups are arranged in photographing date and time order.

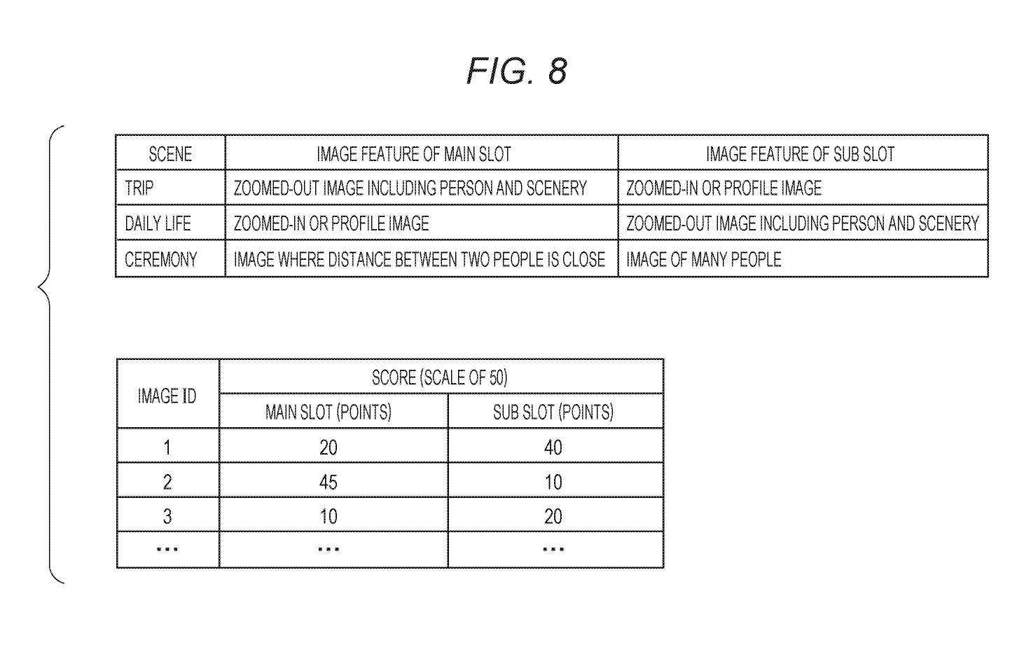

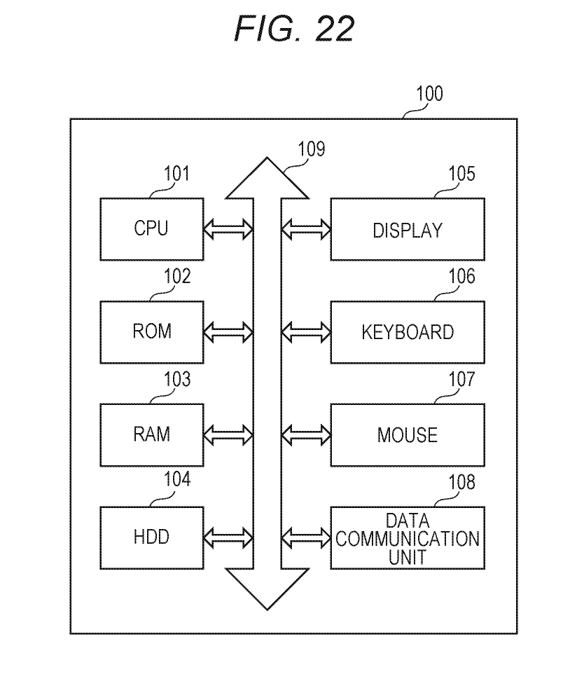

In S423, the CPU 101 causes the image selection unit 213 to select images. A description is given here of an example where four pieces of image data are selected from a divided image data group allocated to a certain double-page spread, with reference to FIGS. 9A to 91. A double-page spread is an area equal to two pages. However, each of the first and last double-page spreads is an area equal to one page.

FIG. 9A illustrates a time difference (divided photographing period) between the photographing dates and times of image data whose photographing date and time is the earliest and image data whose photographing date and time is the latest among a divided image data group allocated to a double-page spread, that is, a photographing period of the divided image data group. Here, image data is selected for the main slot first, and then for the sub slots. A template corresponding to a double-page spread is assumed here to include one main slot 1002. Hence, image data selected first is image data for the main slot. The CPU 101 selects image data (1) whose score for the main slot added in S416 is the highest, as the image data for the main slot, from image data corresponding to the divided photographing period illustrated in FIG. 9B.

Pieces of image data selected second and later times are image data for the sub slots. The second and later pieces of the image data are selected in a method described below to prevent focusing on part of the divided photographing period. Firstly, the CPU 101 divides the divided photographing period into two as illustrated in FIG. 9C. Next, as illustrated in FIG. 9D, the CPU 101 selects the second image data from image data generated during a divided photographing period (a period indicated by a solid line in FIG. 9D) where the first image data was not selected. Image data (2) whose score for the sub slot is the highest is selected as the second image data from the image data generated during the divided photographing period where the first image data was not selected. Next, as illustrated in FIG. 9E, the CPU 101 divides each divided photographing period illustrated in FIG. 9D into two. As illustrated in FIG. 9F, the CPU 101 then selects third image data from image data generated during divided photographing periods (periods indicated by solid lines in FIG. 9F) where neither of the first and second image data was selected. Image data (3) whose score for the sub slot is the highest is selected as the third image data from the image data generated during the divided photographing periods where neither of the first and second image data was selected. Image data whose score for the sub slot is the highest is then selected as fourth image data from image data generated during the divided photographing period where none of the first, second, and third image data was selected.

Next, a description is given of an example where there is no image generated during the divided photographing period where none of the first, second, and third image data was selected, and the fourth image data cannot be selected from the image data generated during the divided photographing period. As illustrated in FIG. 9G, it is assumed here that there is no image data generated during the divided photographing period (a period indicated by oblique lines in FIG. 9G) where no image data has been selected. In this case, the CPU 101 further divides each divided photographing period into two as illustrated in FIG. 9H. Next, as illustrated in FIG. 9I, the CPU 101 selects the fourth image data from images generated during divided photographing periods (periods indicated by solid lines in FIG. 9I) where no image data has been selected, other than the divided photographing periods recognized that there is no image data generated during the periods. The CPU 101 selects image data (4) whose score for the sub slot is the highest as the fourth image data from the image data generated during the divided photographing periods.

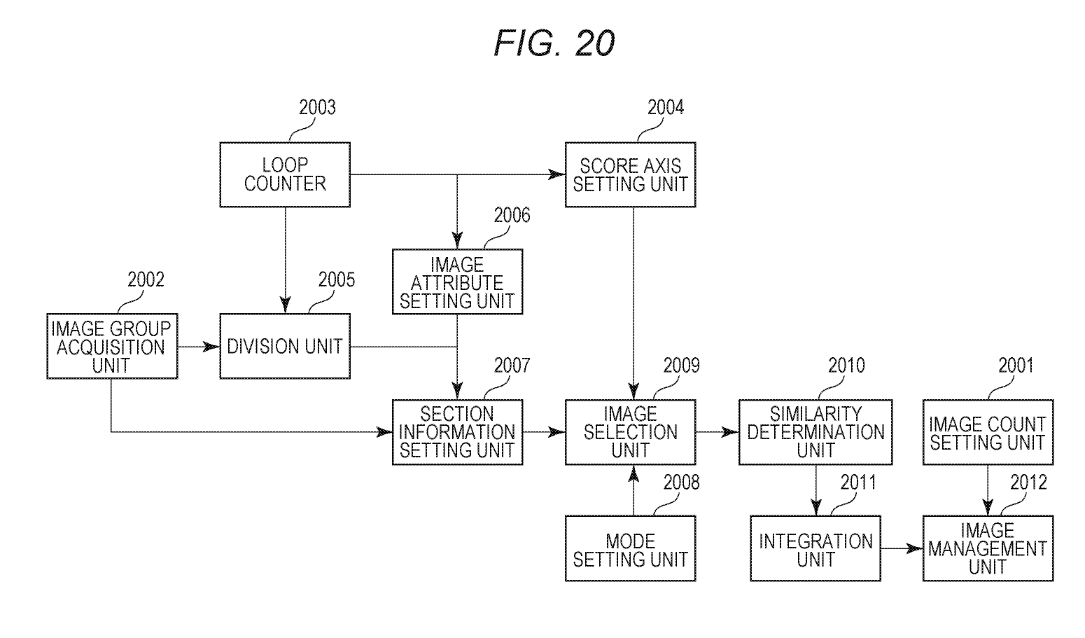

FIG. 20 is a diagram explaining the configuration of the image selection unit 213 in more detail. The image selection unit 213 selects image data from a sub image group allocated to a double-page spread targeted to be processed.

An image count setting unit 2001 sets the number of pieces of image data selected from the sub image group allocated to the double-page spread targeted to be processed. In other words, the image count setting unit 2001 sets the number of images to be placed in a layout image of the double-page spread targeted to be processed.

An image group acquisition unit 2002 acquires the sub image group allocated to the double-page spread targeted to be processed, from an image group acquired by the image acquisition unit 205.

A loop counter 2003 manages the number of execution times of the process of selecting image data from the sub image group acquired by the image group acquisition unit 2002 (the image selection process). In the embodiment, one image is selected to be placed in the template in each loop. Accordingly, the number of execution times counted by the loop counter 2003 is equal to the number of pieces of selected image data.

A score axis setting unit 2004 sets a score axis used in the image selection process, according to the number of execution times of the process counted by the loop counter 2003. “Setting a score axis used” indicates “setting the use of a score rated along which score axis”. A score axis for the main slot (an assessment criterion for the main slot), or a score axis for the sub slot (an assessment criterion for the sub slot) is set here.

A division unit 2005 divides a photographing period for the sub image group acquired by the image group acquisition unit 2002 into a predetermined number.

An image attribute setting unit 2006 sets the attribute of the image data selected in the image selection process, according to the number of execution times of the process counted by the loop counter 2003.

A section information setting unit 2007 groups image data included in the sub image group acquired by the image group acquisition unit 2002 according to the sections divided by the division unit 2005, and acquires the photographic information and information on scores and the like of image data generated in each section.

A mode setting unit 2008 sets the mode (any of “people”, “animals”, and “food”) of the album, which has been designated by the album creation condition designation unit 201. The mode setting unit 2008 controls in such a manner as to place an image including an object corresponding to the set mode in the template.

An image selection unit 2009 executes the image selection process on the basis of the score axis set by the score axis setting unit 2004, the mode set by the mode setting unit 2008, and the scores of image data of each section, the scores being managed by the section information setting unit 2007. Specifically, the image selection unit 2009 selects one piece of image data having the highest score from image data included in a plurality of pieces of image data in each section, the image data representing an image including the designated object, the image data having the designated attribute. The designated object is set to select image data without depending only on the score. When the designated object is set, image data representing an image including the designated object is selected in the following image selection process. For example, when the designated object is an object in the “animals” category, image data representing an image including an object in the “animals” category is selected in the following image selection process. A plurality of objects can be set as the designated objects. The image selection unit 2009 does not newly select already selected image data. In other words, the image selection unit 2009 newly selects image data other than the already selected image data.

A similarity determination unit 2010 determines whether or not an image represented by the image data selected by the image selection unit 2009 is similar to an image represented by image data already selected as image data representing an image to be placed in the template.

An integration unit 2011 specifies image data representing an image to be placed in a template from image data representing images that have been determined by the similarity determination unit 2010 to be dissimilar.

An image management unit 2012 manages the image data that has been specified by the integration unit 2011 as the image data representing the image to be placed in the template, as the already selected image data. Moreover, the image management unit 2012 determines whether or not the number of pieces of the already selected image data has reached the number (required number) of images set by the image count setting unit 2001.

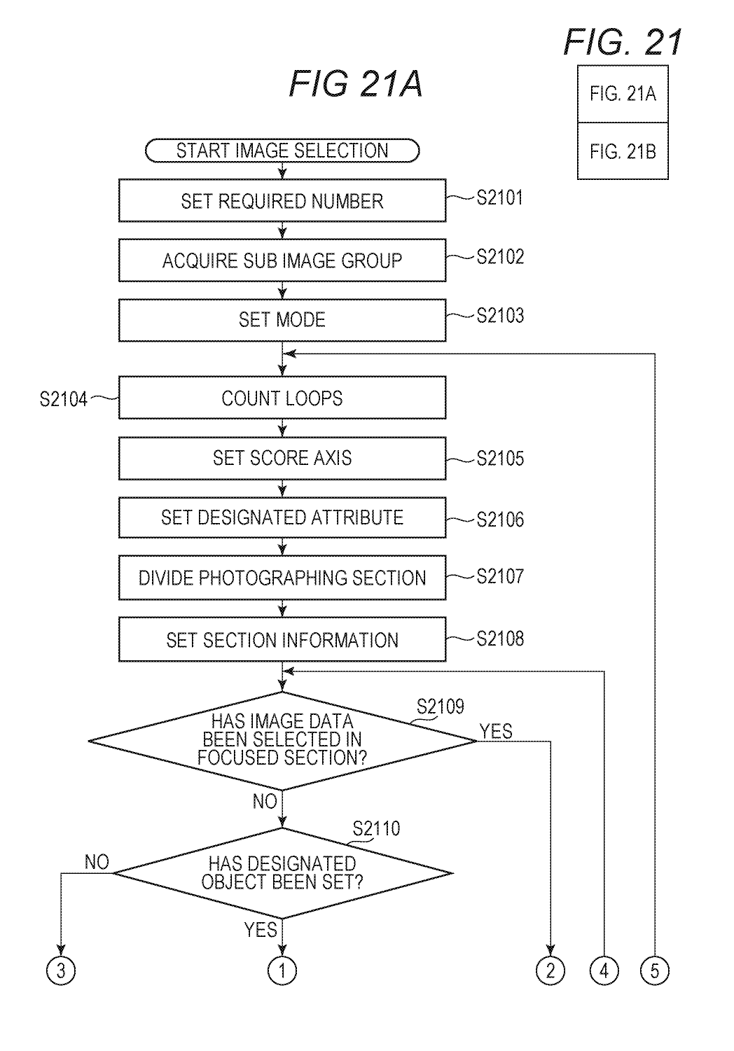

FIGS. 21A and 21B are flowcharts illustrating the details of the image selection process in S423. The flowcharts illustrated in FIGS. 21A and 21B are achieved by, for example, the CPU 101 reading the program corresponding to the album creation app stored in the HDD 104 to the ROM 102 or the RAM 103 and executing the program. In the flowcharts of FIGS. 21A and 21B, image data is selected from a sub image group allocated to one double-page spread targeted to be processed. Hence, when the album consists of a plurality of double-page spreads, the process illustrated in the flowcharts of FIGS. 21A and 21B is executed the number of times corresponding to the number of double-page spreads.

In S2101, the CPU 101 causes the image count setting unit 2001 to set the number of pieces of image data to be selected from a sub image group allocated to a double-page spread targeted to be processed.

In S2102, the CPU 101 causes the image group acquisition unit 2002 to acquire the sub image group allocated to the double-page spread targeted to be processed, from an image group acquired by the image acquisition unit 205.

In S2103, the CPU 101 causes the mode setting unit 2008 to set the mode of the album.

In S2104, the CPU 101 causes the loop counter 2003 to count the number of execution times of the image selection process of S2105. In an initial state, the image selection process has not been executed. Accordingly, the count of the loop counter 2003 is zero. In the embodiment, when the count of the loop counter 2003 is zero, a main image is selected in the following image selection process, and when the count of the loop counter 2003 is one or greater, a sub image is selected in the following image selection process.

In S2105, the CPU 101 causes the score axis setting unit 2004 to set a score axis used in the following image selection process, according to the count obtained by the loop counter 2003.

In S2106, the CPU 101 causes the image attribute setting unit 2006 to set the attribute of image data selected in the following image selection process, according to the count obtained by the loop counter 2003.

In S2107, the CPU 101 causes the division unit 2005 to divide into a predetermined number a photographing period of the sub image group acquired by the image group acquisition unit 2002.

In S2108, the CPU 101 causes the section information setting unit 2007 to group image data included in the sub image group acquired by the image group acquisition unit 2002, according to the sections managed by the division unit 2005 dividing the photographing period of the sub image group. The CPU 101 then acquires the photographic information and information on scores and the like of image data generated in each section.

In S2109, the CPU 101 determines whether or not image data generated in a focused section among the sections managed by the division unit 2005 dividing the photographing period of the sub image group has been selected.

In S2110, the CPU 101 determines whether or not a designated object has been set.

In S2111, the CPU 101 determines whether or not the image data generated in the focused section includes image data representing images including the designated object, the image data having a designated attribute.

In S2112, the CPU 101 selects one piece from the image data generated in the focused section. Here, one piece of image data scored the highest is selected from the image data representing the images including the designated object, the image data having the designated attribute. Hence, in the embodiment, for example, image data representing an image including the designated object, the image data having a low score, is prioritized over image data representing an image without the designated object, the image data having a high score, and is selected. Moreover, in the embodiment, for example, image data having the designated attribute and a low score is prioritized over image data having a high score without the designated attribute, and is selected.

In this manner, in the embodiment, image data is not selected with reference only to scores but is selected with reference to a designated object and a designated attribute. In such a mode, the selection of image data representing an image including a designated object can be further ensured if a sub image group includes image data that agrees with the conditions.

In S2113, the CPU 101 selects one piece from the image data generated in the focused section.

In S2112 and S2113, if there is no image data that agrees with the conditions, no image data is selected. Execution proceeds to the next step.

In S2114, the CPU 101 determines whether or not the image represented by the image data selected in the process of S2112 or S2113 is similar to an image represented by image data already selected in the process of S2118 in the previous loop.

In S2116, the CPU 101 determines whether or not all the sections managed by the division unit 2005 dividing the photographing period of the sub image group have been focused and the process of S2112 or S2113 has been executed on all the sections. If the image selection process has not been executed focusing on all the sections, the CPU 101 selects one of sections that have not yet been focused and executes the process of S2109 and the subsequent steps again.

In S2117, the CPU 101 determines whether or not even one piece of image data has been selected after all the sections have been focused and the image selection process has been executed on all the sections.

In S2121, the CPU 101 updates the designated object.

In S2122, the CPU 101 updates the designated attribute.

In this manner, if at least one of S2121 and S2122 is executed, the conditions of image data being a search target are changed. Accordingly, the CPU 101 can newly select image data. If the information is updated in S2121 and S2122, the CPU 101 treats a section that has already been focused using the pre-update information, as one that has not yet been focused, and again performs the process of S2109 and the subsequent steps.

In S2118, the CPU 101 causes the integration unit 2011 to specify image data representing an image to be placed in the template from image data that has been determined in S2112 to be dissimilar and is still being selected.

In S2119, the CPU 101 causes the image management unit 2012 to manage, as the already selected image data, the image data specified in S2118 as the image data representing the image to be placed in the template.

In S2120, the CPU 101 determines whether or not the number of pieces of the already selected image data managed by the image management unit 2012 has reached the number (required number) of images set by the image count setting unit 2001. When the number of pieces of the already selected image data has reached the required number, the CPU 101 finishes the image selection process and proceeds to S424. On the other hand, when the number of pieces of the already selected image data has not reached the required number, the CPU 101 proceeds again to S2104, increments the count of the loop counter 2003, and performs the image selection process again.

In the above-mentioned mode, the CPU 101 can select image data according to the set mode of the album. Specifically, the CPU 101 can preferentially select image data representing an image including a designated object corresponding to the set mode of the album.

Return to FIG. 4B. In S424, the CPU 101 causes the template setting unit 214 to acquire a plurality of templates corresponding to the template information designated by the album creation condition designation unit 201.

In S425, the CPU 101 causes the image layout unit 215 to determine the image layout of the double-page spread targeted to be processed.

In S426, the CPU 101 causes the image correction unit 217 to correct the image.

In S427, the CPU 101 causes the layout information output unit 218 to create layout information. Specifically, the CPU 101 manages image data on which the image correction of S426 has been executed, the image data corresponding to each slot of the template selected in S425, tying the image data to the slot. The image used here is the analyzed image generated in S407, and is an image different from the image used in S408 to S418. The CPU 101 then generates bitmap data where images are laid out in the template. At this point in time, the CPU 101 scales the images to be laid out to the size information of the slots and lays them out.

In S428, it is determined whether or not the process of S423 to S427 has been finished on all the double-page spreads. If the process has not been finished (No in S428), execution returns to S423. The process of S423 to S427 is performed on a double-page spread that has not yet been targeted to be processed.

When the automatic layout process has been finished, the CPU 101 displays, on the display 105, the layout image where the images have been placed in the template on the basis of the created layout information. At this point in time, the CPU 101 may display a plurality of layout images for creating one album. Moreover, the CPU 101 may transmit the created layout information to a printer such as the image forming apparatus 200, and print the layout image. The printing of the layout image leads to the creation of the album.

In the above-mentioned automatic layout process, a template and image data are selected automatically (without accepting a selection instruction from a user) by the album creation app to generate a layout image. However, an image represented by layout information is not limited to one including a template and an image represented by image data. This is because layout information in the embodiment is used to create an album, but the album also includes, for example, areas where an image represented by image data is not generally printed, called an endpaper, an endleaf, a title page, and a colophon. In the embodiment, the layout information also represents images corresponding to the endpaper, the endleaf, the title page, and the colophon. Data representing these images is not generated by the above-mentioned automatic layout process. Accordingly, data created in advance as the images corresponding to the endpaper, the endleaf, the title page, and the colophon is assumed to be included in layout information at any timing.

In the embodiment, the details of the automatic layout process are not limited to the above-mentioned mode. For example, the method for selecting a template used in an album and selecting image data representing an image placed in the template are not limited to the above-mentioned mode. It is sufficient as long as it is a mode in which layout information is created without a user making, for example, at least the selection of a template to be used in an album, and the selection of image data representing an image to be placed in the template.

<Editing of an Album>

The CPU 101 creates layout information as described above, and then displays a screen for accepting the editing of an album represented by the created layout information. A user can check, on the screen, the contents of the album represented by the layout information created by the automatic layout process. Such a screen is hereinafter referred to as the editing screen. In the embodiment, one of a plurality of double-page spreads of the album represented by the created layout information is displayed on the editing screen. The double-page spreads displayed are switched according to the user's operation. At this point in time, the album may be displayed not on a double-page spread basis but on a page basis on the editing screen. Moreover, a double-page spread that is displayed on the editing screen immediately after the automatic layout process is finished is not especially limited, and may be, for example, the first double-page spread, or a double-page spread with the highest importance level described below, among the plurality of double-page spreads. It is assumed in the embodiment that the double-page spread that is displayed on the editing screen immediately after the automatic layout process is finished is the first double-page spread (a double-page spread whose double-page spread name is “front cover”) among the plurality of double-page spreads.

One example of the editing screen is illustrated in FIG. 13. A display area 1301 represents one double-page spread. One double-page spread here indicates an area equal to two pages facing each other in an album. In the embodiment, one template is provided to one double-page spread. Accordingly, one template and images placed in the template are displayed in the display area 1301. The relationship between the cover (front cover) and the back cover does not correspond to the above-mentioned definition of a double-page spread. However, in the embodiment, the cover and the back cover are regarded as one double-page spread, and are displayed side by side in the display area 1301. Moreover, the display area 1301 is not limited to the mode of representing one double spread, but, for example, may be in a mode of representing one page. Moreover, the display area 1301 may switch between the state of representing one double-page spread and the state of representing one page. In this case, for example, the display area 1301 displays the cover and the back cover in the state of representing one page, and the body in the state of representing one double-page spread.

A slot 1309 is a slot in a double-page spread displayed in the display area 1301. Moreover, a text box 1310 is an area, where a text can be input, in the double-page spread displayed in the display area 1301.

A thumbnail area 1302 is an area that displays thumbnails corresponding to double-page spreads of the album in list form. When the user selects a thumbnail, a double-page spread corresponding to the selected thumbnail is displayed in the display area 1301. In other words, the user selects a thumbnail and accordingly can view a double-page spread corresponding to the selected thumbnail.

Moreover, an icon 1303 is an icon indicating that a double-page spread corresponding to a thumbnail has not yet been viewed. The icon 1303 is a check mark in FIG. 13, but is not limited to this mode and may be, for example, a round mark.

Double-page spread feed buttons 1304 and 1305 are buttons for switching a double-page spread displayed in the display area 1301. When the double-page spread feed button 1304 is pressed, a double-page spread prior to a double-page spread displayed in the display area 1301 at this point in time is displayed. Moreover, when the double-page spread feed button 1305 is pressed, a double-page spread subsequent to a double-page spread displayed in the display area 1301 at this point in time is displayed. In this manner, the user can switch double-page spreads displayed in the display area 1301, not by the method in which a thumbnail in the thumbnail area 1302 is selected, but by operating these buttons.

An album editing button 1306 is a button for changing settings related to the entire album. The entire album indicates all double-page spreads and pages included in the album. In other words, the user presses the album editing button 1306 and accordingly can edit/change the entire album at a time. The settings related to all the double-page spreads and pages included in the album are not necessarily changed by the album editing button 1306. It is sufficient if settings related to at least one or more double-page spreads and pages are changed.

Moreover, in the embodiment, when the album editing button 1306 is pressed, an album editing screen 1400 for accepting input for editing/changing the ratio of objects included in the entire album is displayed on top of the editing screen. The details of the album editing screen 1400 are described below.

A double-page spread editing button 1307 is a button for changing settings related to a double-page spread displayed in the display area 1301. Specifically, for example, the double-page spread editing button 1307 is a button for changing a template corresponding to the double-page spread, an image included in the double-page spread, and the importance level of the double-page spread, and adding/inputting a text. The settings related to the double-page spread displayed in the display area 1301 can also be changed by, for example, directly operating the slot 1309 and the text box 1310.

An album order button 1308 is a button for placing an order for an album. When the album order button 1308 is pressed, layout information based on settings at this point in time is transmitted (uploaded) to the external server 400, and an album is created on the basis of the layout information.

<Editing of the Entire Album>

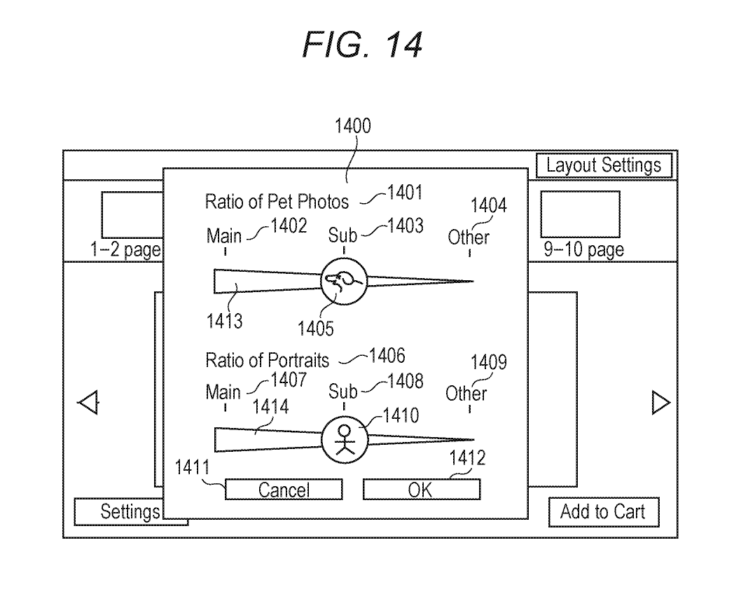

As described above, when the album editing button 1306 is pressed, the album editing screen 1400 is displayed on top of the editing screen. In other words, the screen displayed on the display 105 enters such a state as illustrated in FIG. 14.

The album editing screen 1400 is a UI for adjusting the frequency of occurrence of objects in the edited album. The album editing screen 1400 is provided by the album creation app. Contents in the mode of the created album (the pre-editing album) are displayed on the album editing screen 1400. Specifically, an area is displayed which is for adjusting the frequency of occurrence of images including objects corresponding to the mode of the album (the frequency of selection of images to be placed in the template) in the edited album. For example, when the mode of the created album is “animals”, an area 1401 is displayed which is for adjusting the frequency of occurrence of images including objects of “animals” in the edited album. It is assumed in the embodiment that an area 1406 for adjusting the frequency of occurrence of images including objects of “people” in the edited album is displayed in any mode of the album. In the embodiment, a mode is set in which an area for adjusting the frequency of occurrence of images including objects other than “people” is displayed only when the mode of an album is other than “people”. However, the embodiment is not limited to this mode. For example, it may be a mode in which the area is displayed in any mode of the album.

A method for editing an album using the album editing screen 1400 is described in detail below. A description is given here, taking as an example a case where the mode of a created album is “animals”.

The user performs input to move a knob 1405 and a knob 1410 to enable the adjustment of the frequency of occurrence of images including objects corresponding to each area in the edited album. It is assumed in the embodiment that three types of setting values—“Main” (the maximum value), “Sub” (the intermediate value), and “Other” (the minimum value)—are provided. The frequency of occurrence of images is adjusted according to the setting values corresponding to inputs by the user (the setting values corresponding to the positions of the knobs 1405 and 1410). Specifically, the magnitude relationship of the frequency of occurrence is images including objects set at “Main”>images including objects set at “Sub”>images including objects set at “Other”.

A bar 1413 of an animals-specific slider is a slider for adjusting the frequency of occurrence of images including objects of “animals”. The animals-specific slider is assumed in the embodiment to extend in the horizontal direction, but may extend in, for example, the vertical direction. A bitmap image representing an animal is placed on the knob 1405 placed on the bar 1413. The bitmap image may be an object of an animal extracted from images adopted in the album, or an image of a general animal. Moreover, it may be an icon that recalls an animal such as an icon mimicking a pad. The images adopted in the album are the images represented by the image data selected in S423.

A bar 1414 of a people-specific slider is a slider for adjusting the frequency of occurrence of images including objects of “people”. The people-specific slider is assumed to be a slider that is substantially parallel to the animals-specific slider. A bitmap image representing a person is placed on the knob 1410 placed on the bar 1414. The bitmap image may be an object of a person extracted from the images adopted in the album, or an image of a general person.

The areas corresponding to the sliders are not limited to areas corresponding to the bars, and include areas where at least the knobs are movable.

In this manner, the bitmap images representing the objects corresponding to the knobs are placed on the knobs, respectively. Accordingly, it is possible to clearly indicate, to the user, the correspondence of the knobs to the objects.

The knobs are dragged by an operator such as a mouse or finger to be moved. However, it may be a mode in which when each area indicating the position for setting the setting value, such as “Main” 1402 or “Sub” 1403, is clicked, the relevant knob moves to the position corresponding to the clicked area.

When the user presses an OK button 1412, the album is edited on the basis of the input setting values. In other words, the automatic layout process is performed again on the basis of the input setting values. For example, the process of S423 to S428 may be performed again in the second automatic layout process. In this case, the score given in S416 upon the creation of the pre-editing album is referred to also in S423 in the image selection process.

When the user presses a cancel button 1411, the adjustment of the frequency of occurrence is canceled. The album editing screen 1400 is then closed. In other words, the screen displayed on the display 105 returns to such a state as illustrated in FIG. 13.

The method for setting the frequency of occurrence of images including objects corresponding to each area is not limited to the above-mentioned mode. Although the mode in which the knob is moved to the left or right to select the setting value is described above, it may be, for example, a mode in which the slider extends vertically, and the knob is moved up or down to select the setting value. Moreover, the setting values may not be “Main”, “Sub”, and “Other”, but may be expressed by, for example, numeric characters, symbols, or other words. The setting values may be expressed as, for example, “many” (the maximum value), “standard” (the intermediate value), and “few” (the minimum value). Moreover, the setting values are not limited to the three types, the maximum value, the intermediate value, and the minimum value, and may be two types. Alternatively, the setting values may be further classified into three or more types.

As described above, the knob is moved along the slider to enable the change of the setting value. However, in a mode in which the state of the knob on the move does not correspond to the moving direction and the position of the knob, or in a mode in which the knobs on the plurality of sliders move in similar states, it is difficult for the user to have positive feelings such as “fun” and “amusement” brought by moving the knobs. Moreover, in such a mode, it is difficult to present the user the meanings of the setting values selected by moving the knobs and the moving directions of the knobs.

Hence, in the embodiment, a mode in which usability in the operation of moving the knob is improved is described.

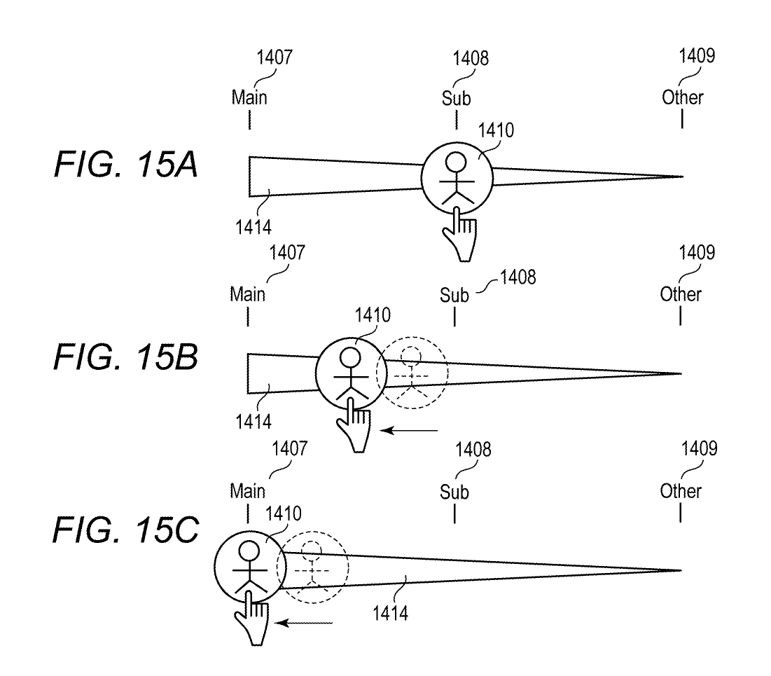

Firstly, the operation of changing the setting value related to objects of “people” is described using FIGS. 15(A) to 15(C). As illustrated in FIG. 15(A), it is assumed in the initial state that the knob 1410 is at rest at the position of “Sub” 1408 indicating that the setting value is the intermediate value. When desiring to change the setting value to the maximum value, the user moves the knob 1410 to the left by an operator such as a mouse or finger. It is assumed in the embodiment that the knob for changing the setting value related to objects of “people” moves straight as before. Hence, the knob 1410 moves straight (along a straight track) and in an unrotated state from the position of “Sub” 1408 to the position of “Main” 1407 indicating that the setting value is the maximum value. FIG. 15(B) illustrates the process of the knob 1410 moving to the left. FIG. 15(C) illustrates a state where the knob 1410 has moved straight to the position of “Main” 1407.

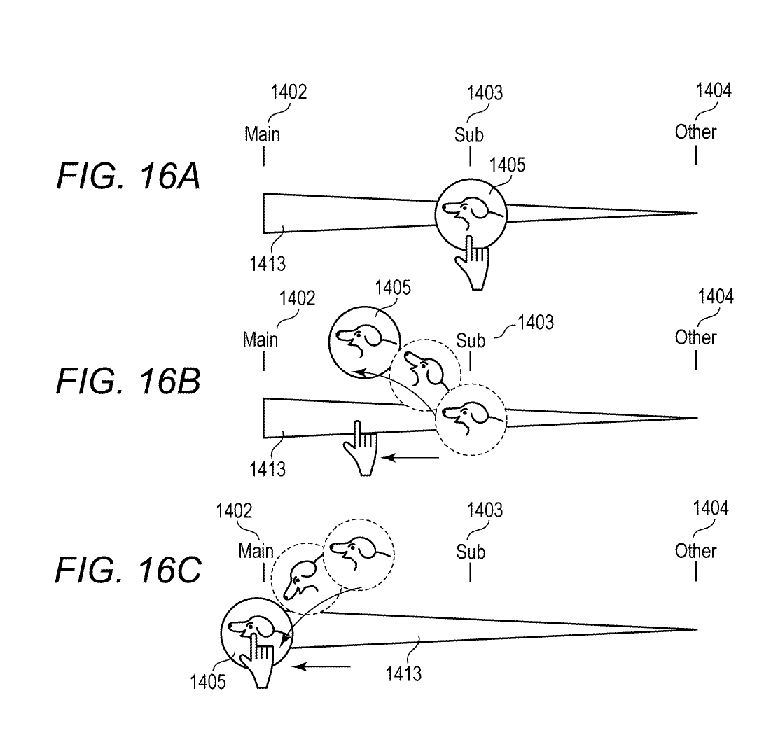

Next, the operation of changing the setting value related to objects of “animals” from the intermediate value to the maximum value is described using FIGS. 16(A) to 16(C). As illustrated in FIG. 16(A), it is assumed in the initial state that the knob 1405 is at the position of “Sub” 1403 indicating that the setting value is the intermediate value. When desiring to change the setting value to the maximum value, the user moves the knob 1405 to the left by an operator such as a mouse or finger. It is assumed in the embodiment that the knob for changing the setting value related to objects of “animals” moves in changing motion. Specifically, for example, when moving leftward, that is, in a direction to change the setting value toward the maximum value, the knob 1405 moves not straight but through an arc (along an arc track). In other words, the direction to change the setting value toward the maximum value is a direction to increase the number of images adopted including objects corresponding to the knob 1405. Moreover, at this point in time, the knob 1405 may move in a rotating state according to the moving direction with respect to the orientation before the movement. In other words, the knob 1405 is in a state of rotating upward with respect to the orientation before the movement (that is, a state where an image related to an “animal” object is oriented upward) while moving toward the vertex of the arc. FIG. 16(B) illustrates the process of the knob 1405 moving toward the vertex of the arc. The knob 1405 returns to the original height (a height when the knob 1405 is at the position of “Sub” 1403) when moving to the position of “Main” 1402. Moreover, the knob 1405 is in a state of rotating downward with respect to the orientation before the movement (that is, a state where the image related to the “animal” object is oriented downward) while moving toward a landing point on the bar over the vertex of the arc. FIG. 16(C) illustrates the process of the knob 1405 moving from the vertex of the arc to the position of “Main” 1402.

As described above, the bitmap image representing an animal is placed on the knob 1405. Hence, when moving in the direction to change the setting value to the maximum value, the knob 1405 moves through an arc. Accordingly, it is possible to express motion that looks as if the animal is jumping with joy. The expression of the animal in joy indicates an increase in the number of images adopted including animal objects in the edited album when the setting value is changed to the maximum value.

The track of the knob 1405 describes an arc when the knob 1405 moves in the direction to change the setting value toward the maximum value. Accordingly, the expression as if an animal is jumping is achieved. However, the track of the knob 1405 is not limited to this mode. For example, a state that the animal is running lively may be expressed by moving the knob 1405, slightly up and down, along a zigzag track. Moreover, for example, a state that the animal is bouncing and moving may be expressed by moving the knob 1405 through a plurality of arcs. In other words, any mode is acceptable as long as the knob 1405 moves along a track in accordance with the moving direction.

Moreover, the movement of the knob 1405 of when the setting value related to objects of “animals” is changed from the minimum value to the intermediate value or the maximum value is also similar to the above-mentioned movement.

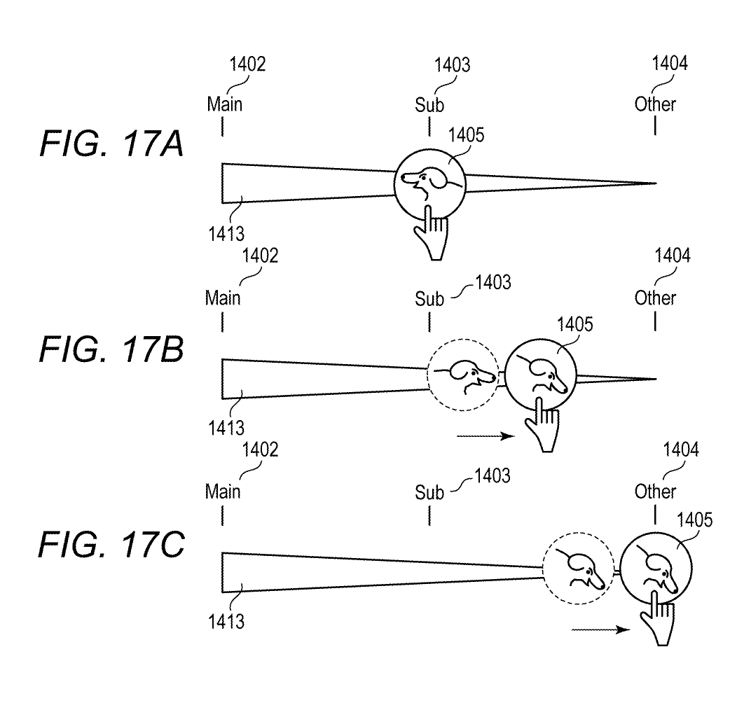

Next, the operation of changing the setting value related to objects of “animals” from the intermediate value to the minimum value is described using FIGS. 17(A) to 17(C). As illustrated in FIG. 17(A), it is assumed in the initial state that the knob 1405 is at the position of “Sub” 1403 indicating that the setting value is the intermediate value. When desiring to change the setting value to the minimum value, the user moves the knob 1405 to the right by an operator such as a mouse or finger. When moving rightward, that is, a direction to change the setting value toward the minimum value, the knob 1405 rotates the image placed on the knob 1405 in such a manner as to cause the image to face down. In other words, the direction to change the setting value toward the minimum value is a direction to reduce the number of images adopted including objects corresponding to the knob 1405. Moreover, at this point in time, the knob 1405 moves straight from the position of “Sub” 1403 to the position of “Other” 1404. FIGS. 17(B) and 17(C) illustrate the process of the knob 1405 moving to the right. When moving in the direction to change the setting value to the minimum value, the knob 1405 is rotated in such a manner as to cause the image placed on the knob 1405 to face down. Accordingly, it is possible to express motion that looks as if the animal is hanging its head in sorrow. The expression of the animal in sorrow indicates a reduction in the number of images adopted including animal objects in the edited album when the setting value is changed to the minimum value.

Moreover, it is assumed that the orientation of the animal represented by the image placed on the knob 1405 is switched as appropriate to agree with the moving direction of the knob 1405. In other words, in this example, the animal represented by the image placed on the knob 1405 faces left in the initial state. Accordingly, when the knob 1405 moves to the right, the orientation of the animal is reversed to the right.

Here, the knob 1405 is rotated in such a manner as to cause the image placed on the knob 1405 to face down when the knob 1405 moves in the direction to change the setting value toward the minimum value. However, the rotation amount and rotation direction of the knob 1405 are not limited to this mode, and any mode is acceptable as long as the knob 1405 moves in a state of having been rotated in a direction in accordance with the moving direction.

Moreover, the knob 1405 may be controlled in such a manner as to move along an arc track when moving in either direction. At this point in time, for example, the track of the knob 1405 is controlled in such a manner as to move through a large arc when moving in the direction to change the setting value toward the maximum value, and move through a small arc when moving in the direction to change the setting value toward the minimum value. Consequently, when the knob 1405 moves in the direction to change the setting value toward the maximum value, it is possible to express motion that looks as if the animal is jumping high with joy.

As described above, in the embodiment, the knob for changing the setting value related to objects of “people” is controlled in such a manner as to move straight, and the knob for changing the setting value related to objects of “animals” is controlled in such a manner as to move in a changing manner. In other words, in the embodiment, it is controlled in such a manner that the state of the knob on the move varies depending on the type of object corresponding to the knob.

In other words, the control is as described below. Let the amount of change in element, other than a position in the horizontal direction, between the state of the knob 1405 at the time of stopping at a stopping position on the animals-specific slider and the state of the knob 1405 at the time of having moved a predetermined distance A in the horizontal direction from the stopping position be a first change amount. Specifically, the first change amount is, for example, the amount of change between the state of the knob 1405 illustrated in FIG. 16(A) and the state of the knob 1405 indicated by a solid line in FIG. 16(B). Let the amount of change in element, other than a position in the horizontal direction, between the state of the knob 1410 at the time of stopping at a stopping position on the people-specific slider and the state of the knob 1410 at the time of having moved the predetermined distance A in the horizontal direction from the stopping position be a second change amount. Specifically, the second change amount is, for example, the amount of change between the state of the knob 1410 illustrated in FIG. 15(A) and the state of the knob 1410 indicated by a solid line in FIG. 15(B). In the embodiment, it is controlled in such a manner as to make the first and second change amounts different.

In this manner, the knobs on the sliders are controlled in such a manner as to move with different amounts of change when moving a similar distance in the horizontal direction. Accordingly, the user can enjoy the difference between the movements of the knobs on the sliders. Specifically, the element other than a position in the horizontal direction is, for example, a position in the vertical direction (a direction substantially orthogonal to the horizontal direction). The tracks of the knobs are made different. As a result, the positions of the knobs in the vertical direction are different when having moved a predetermined distance. Moreover, the element other than a position in the horizontal direction may be an element such as the rotation amount and rotation direction of the knob, or the orientation of the knob. For example, in the embodiment, in the case of moving in the direction to change the setting value to the minimum value, the knob 1405 is rotated in such a manner that the image placed on the knob 1405 faces down, and the knob 1410 is not rotated. Consequently, the knobs vary in the amount of change in rotation amount and rotation direction. In terms of the control, it may be controlled in such a manner that not only one element but two or more elements vary.

Moreover, as described above, in the embodiment, it is controlled in such a manner that the states of the knobs on the move vary depending on the directions in which the knobs move. In other words, the control is as described below. Let the mount of change in element, other than a position in the horizontal direction, between the state of the knob 1405 at the time of stopping at a stopping position on the animals-specific slider and the state of the knob 1405 at the time of having moved the predetermined distance A to the left from the stopping position on the animals-specific slider be a third change amount. Specifically, the third change amount is, for example, the amount of change between the state of the knob 1405 illustrated in FIG. 16(A) and the state of the knob 1405 indicated by the solid line in FIG. 16(B). Let the amount of change in element, other than a position in the horizontal direction, between the state of the knob 1405 at the time of stopping at a stopping position on the animals-specific slider and the state of the knob 1405 at the time of having moved the predetermined distance A to the right from the stopping position on the animals-specific slider be a fourth change amount. Specifically, the fourth change amount is, for example, the amount of change between the state of the knob 1405 illustrated in FIG. 17(A) and the state of the knob 1405 indicated by a solid line in FIG. 17(B). In the embodiment, it is controlled in such a manner as to make the third and fourth change amounts different. Also in such a mode, the user can enjoy the difference between the movements of the knobs on the sliders. The element other than a position in the horizontal direction is similar to the above-mentioned example. Also in terms of the control, it may be controlled in such a manner that not only one element but two or more elements vary.

Moreover, in the embodiment, it is controlled in such a manner that the knob for changing the setting value related to objects of “animals” moves, expressing the joy or sorrow of the animal. In this manner, in the embodiment, the state of the knob on the move is put in the state mimicking the object corresponding to the knob; accordingly, it is possible to present the user the correspondence of the sliders to the objects.

In the above description, the knob for changing the setting value related to objects of “people” moves in the known method. However, the embodiment is not limited to this mode. The knob may move in any method other than the above-mentioned method, such as moving along a non-straight track, or moving in a rotated state, as long as the moving method is different from the one of the knob for changing the setting value related to objects of “animals”.

Moreover, it is assumed in the above description that the moving methods of the knobs for changing the setting values related to objects of “people” and “animals” are described. However, the present disclosure can also be applied to moving methods of knobs for changing setting values related to other objects such as “food”, “buildings”, “transport”, and “flowers”. As described above, in the embodiment, it is a mode in which a slider for changing a setting value related to objects corresponding to the mode of an album and a slider for changing a setting value related to “people” are displayed. Hence, if the mode of an album is, for example, “transport”, it is set in such a manner that a moving method of a knob for changing a setting value related to “transport” and a moving method of a knob for changing a setting value related to “people” are different.

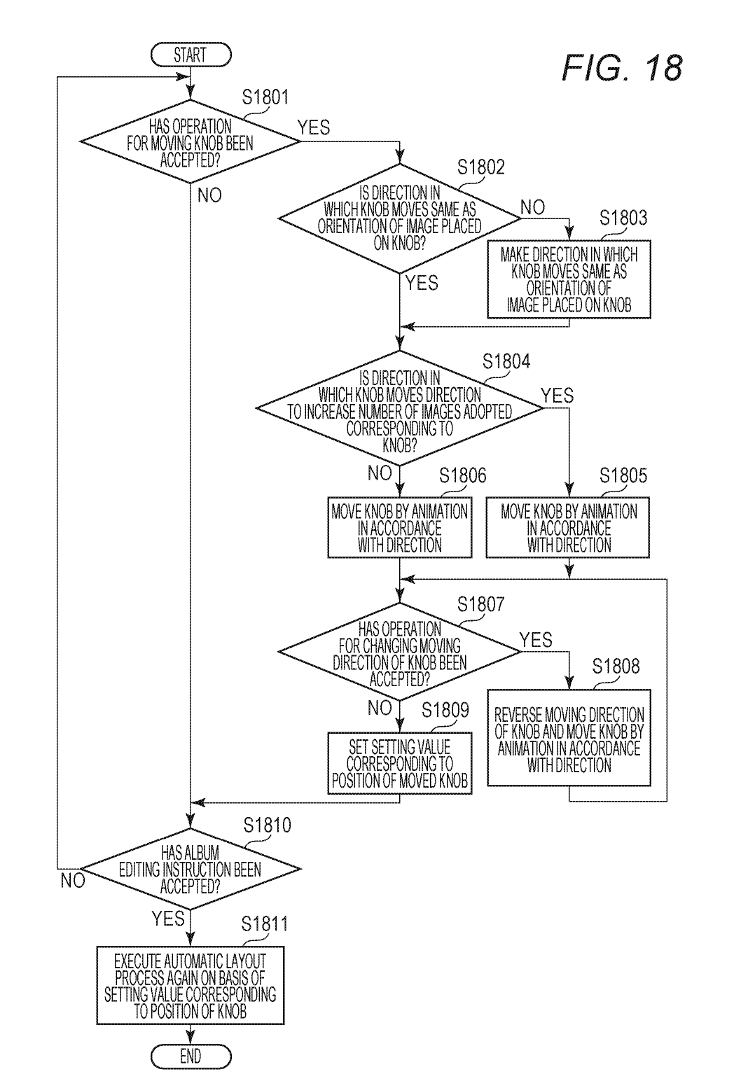

FIG. 18 is a flowchart illustrating a process that is executed by the image processing apparatus 100 when the album editing screen 1400 is displayed. The flowchart illustrated in FIG. 18 is achieved by, for example, the CPU 101 reading the program corresponding to the album creation app stored in the HDD 104 to the ROM 102 or the RAM 103 and executing the program. Moreover, the flowchart illustrated in FIG. 18 is started in a state where the album editing screen 1400 is displayed on the display 105.

Firstly, in S1801, the CPU 101 determines whether or not an operation for moving the knob 1405 has been accepted. In a case of the determination of YES, the CPU 101 proceeds to S1802. In a case of the determination of NO, the CPU 101 proceeds to S1810.

In S1802, the CPU 101 determines whether or not the direction in which the knob 1405 moves on the basis of the accepted operation is the same as the orientation of the object represented by the image placed on the knob 1405. In a case of the determination of YES, the CPU 101 proceeds to S1804. In a case of the determination of NO, the CPU 101 proceeds to S1803.

In S1803, the CPU 101 controls in such a manner that the direction in which the knob 1405 moves on the basis of the accepted operation is the same as the orientation of the object represented by the image placed on the knob 1405. In other words, the CPU 101 reverses the orientation of the object represented by the image placed on the knob 1405. The CPU 101 then proceeds to S1804.

In S1804, the CPU 101 determines whether or not the direction in which the knob 1405 moves on the basis of the accepted operation is the direction to increase the number of images adopted including objects corresponding to the knob 1405. In the embodiment, the direction to increase the number of images adopted including objects corresponding to the knob 1405 is left, and the direction to reduce the number of images adopted including objects corresponding to the knob 1405 is right. In a case of the determination of YES, the CPU 101 proceeds to S1805. In a case of the determination of NO, the CPU 101 proceeds to S1806.

In S1805, the CPU 101 moves the knob 1405 by an animation in accordance with the direction to increase the number of images adopted including objects corresponding to the knob 1405. Specifically, the CPU 101 moves the knob 1405 through an arc. The CPU 101 then proceeds to S1807.

In S1806, the CPU 101 moves the knob 1405 by an animation in accordance with the direction to reduce the number of images adopted including objects corresponding to the knob 1405. Specifically, the CPU 101 rotates and then moves the knob 1405. The CPU 101 then proceeds to S1807.

In S1807, the CPU 101 determines whether or not the operation of changing the moving direction of the knob 1405 has been accepted while the knob 1405 was moving. In a case of the determination of YES, the CPU 101 proceeds to S1808. In a case of the determination of NO, the CPU 101 proceeds to S1809.

In S1808, the CPU 101 reverses the moving direction of the knob 1405, and moves the knob 1405 by an animation in accordance with the reversed moving direction. The CPU 101 then proceeds again to S1807.

In S1809, the CPU 101 identifies the position of the moved knob 1405 and the setting value corresponding to the position of the moved knob 1405, and sets the setting value of objects (“animals” here) corresponding to the knob 1405 at the identified setting value. The CPU 101 then proceeds to S1810.

In S1810, the CPU 101 determines whether or not an instruction to edit the album has been accepted. Specifically, the CPU 101 determines whether or not the OK button 1412 has been pressed. In a case of the determination of YES, the CPU 101 proceeds to S1811. In a case of the determination of NO, the CPU 101 proceeds again to S1801.

In S1810, the CPU 101 executes the automatic layout process again on the basis of the setting value corresponding to the position of the knob 1405. Specifically, the CPU 101 performs the process of S416 to S428 again on the basis of the setting value corresponding to the position of the knob 1405. At this point in time, the CPU 101 may reuse each piece of the information acquired in the process of S401 to S415 at the time of creating the album before editing, as appropriate.

In the automatic layout process that is executed again, for example, the CPU 101 increases or reduces the score of image data representing an image including an object corresponding to the knob 1405 on the basis of the setting value corresponding to the position of the knob 1405, in the image scoring in S416. Specifically, for example, when the setting value corresponding to the position of the knob 1405 is the maximum value, the CPU 101 increases the score of the image data representing the image including the object corresponding to the knob 1405. Moreover, for example, when the setting value corresponding to the position of the knob 1405 is the minimum value, the CPU 101 reduces the score of the image data representing the image including the object corresponding to the knob 1405. When the setting value corresponding to the position of the knob 1405 is the intermediate value, the score of the image data representing the image including the object corresponding to the knob 1405 does not need to be changed.

In the above description, it may not be a mode in which the scores of image data representing images including objects corresponding to the knob 1405 are uniquely increased or reduced. For example, the score of each piece of image data may be individually increased or reduced by being calculated on the basis of an assessment axis corresponding to objects corresponding to the knob 1405. Moreover, each piece of image data may be assessed again on the basis of the assessment axis corresponding to objects corresponding to the knob 1405. Consequently, for example, the assessment of image data that has been highly assessed since the image data represents an image where a “person” object appears well is reviewed, and the assessment of image data representing an image where an “animal” object appears well is highly assessed.

For example, the following image selection process may be executed after the above-mentioned image scoring is executed. For example, the CPU 101 selects image data on the basis of the setting value corresponding to the position of the knob 1405 in the image selection process in S423. Specifically, when the setting value corresponding to the position of the knob 1405 is, for example, the maximum value, the CPU 101 preferentially selects image data representing images including objects corresponding to the knob 1405 irrespective of the magnitude of the score. In other words, even if image data that does not represent images including objects corresponding to the knob 1405 is scored higher than image data representing images including objects corresponding to the knob 1405, the CPU 101 selects the latter image data. Moreover, when the setting value corresponding to the position of the knob 1405 is, for example, the minimum value, the CPU 101 preferentially selects image data that does not represent images including objects corresponding to the knob 1405 irrespective of the magnitude of the score. In other words, even if image data representing images including objects corresponding to the knob 1405 is scored higher than image data that does not represent images including objects corresponding to the knob 1405, the CPU 101 selects the latter image data.

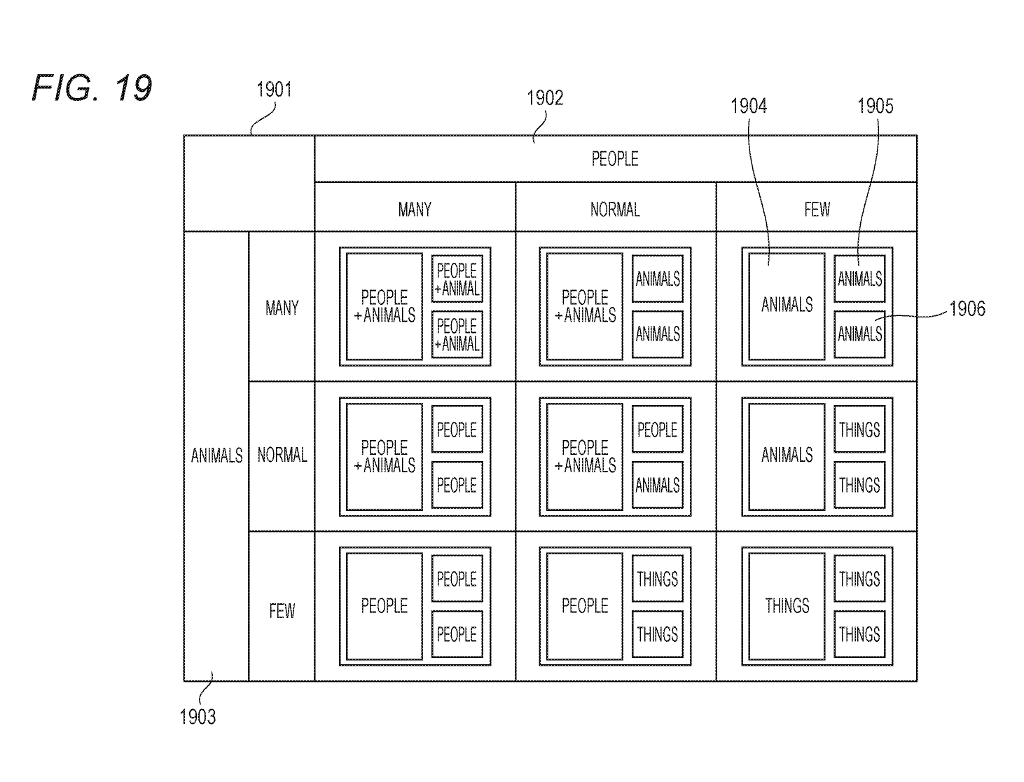

The example has been described in which the above-mentioned image scoring process and image selection process are executed as the automatic layout process that is executed again. However, other processes may be performed as described below. For example, the ratio of objects included in images represented by image data selected in the image selection process in S423 may be changed according to the combination of the setting value corresponding to the position of the knob 1405 and the setting value corresponding to the position of the knob 1410. FIG. 19 is a diagram illustrating layout images of a certain double-page spread in the edited album on the basis of each setting value when such a mode is applied.

A type 1904 indicates the type of image placed in the main slot. Types 1905 and 1906 indicate the types of images placed in the sub slots. “People+animals” indicate an image including both of person and animal objects. “People” indicate an image that includes a “person” object and does not include an animal object. “Animals” indicate an image that includes an animal object and does not include a person object. “Things” indicate an image including neither a person object nor an animal object.

As illustrated in a table 1901, when both of the setting value of “people” and the setting value of “animals” are “Main”, all the images included in the layout image are of the “people+animals” type. Moreover, when the setting value of “people” is “Sub” and the setting value of “animals” is “Main”, an image of the “people+animals” type is placed in the main slot, and images of the “animals” type are placed in the sub slot. Moreover, when the setting value of “people” is “Other” and the setting value of “animals” is “Main”, all the images included in the layout image are of the “animals” type.

Moreover, when the setting value of “people” is “Main” and the setting value of “animals” is “Sub”, an image of the “people+animals” type is placed in the main slot, and images of the “people” type are placed in the sub slots. Moreover, when the setting value of “people” is “Main” and the setting value of “animals” is “Other”, all the images included in the layout image are of the “people” type.

Moreover, when both of the setting values of “people” and “animals” are “Sub”, an image of the “people+animals” type is placed in the main slot, and an image of the “people” type and an image of the “animals” type are placed in the sub slots. Moreover, when the setting value of “people” is “Sub” and the setting value of “animals” is “Other”, an image of the “people” type is placed in the main slot, and images of the “things” type are placed in the sub slots. Moreover, when the setting value of “people” is “Other” and the setting value of “animals” is “Sub”, an image of the “animals” type is placed in the main slot, and images of the “things” type are placed in the sub slots. Moreover, when both of the setting values of “people” and “animals” are “Other”, all the images included in the layout image are of the “things” type.

When the type of image is determined as describe above, image data is selected in decreasing order of scores from image data representing images of the determined type. A layout image where images represented by the selected image data are placed is then created.

The types of images placed in each pattern are not limited to the above-mentioned mode. It is sufficient if the types of images placed in each pattern are different. For example, a slot for which the type of image to be placed is not set may be included. In this case, an image of any type is placed in the slot. For example, among images that have not yet been selected, an image having the highest score is simply placed.

Moreover, it is assumed in FIGS. 21A and 21B that the type of template used to generate a layout image is the same in each pattern. However, the embodiment is not limited to this mode. Image data to be selected is different in each pattern; accordingly, a template suitable for the selected image data is selected in each pattern, as appropriate.

In this manner, the CPU 101 adjusts the scores of image data representing images including objects corresponding to the knob 1405 and a priority level in the image selection process, on the basis of the setting value corresponding to the position of the knob 1405. Consequently, an album represented by layout information output by the automatic layout process that is executed again is based on a result of changes in settings on the album editing screen 1400.

After the automatic layout process is executed again, the album represented by the layout information generated accordingly is displayed on the editing screen.

In this manner, in the embodiment, the state of the knob on the move varies according to the direction in which the knob moves and the type of slider. Specifically, when the moving direction of the knob is the direction to increase the number of images adopted including objects corresponding to the knob, the knob is moved through an arc. Moreover, when the moving direction of the knob is the direction to reduce the number of images adopted including objects corresponding to the knob, the knob is moved in the state of having been rotated downward. Moreover, the states of the knob that is moving along the slider for changing the setting value related to “people” and the knob that is moving along the slider for changing the setting value related to “animals” are made different. In such a mode, it is possible to inspire a user to positive feelings such as “fun” and “amusement” brought by moving the knob. Moreover, it is possible to cause the user to understand the meanings of the setting values selected by moving the knobs and the moving directions of the knobs.

Moreover, in the embodiment, an image related to an object corresponding to each slider is placed on each knob. In such a mode, it is possible to make it easier for the user to understand the meaning of the state of the knob on the move than a mode in which the knob looks plain and simple.

### Other Embodiments

In the above-mentioned embodiment, the image placed on the knob is rotated, or the track of the movement of the knob is changed, according to the moving direction of the knob and the type of slider. However, the embodiment is not limited to this mode. It may be, for example, a mode in which the content of the image placed on the knob is changed according to the moving direction of the knob and the type of slider. In this case, for example, the CPU 101 changes the content to an image illustrating a look of happiness of an object corresponding to the knob when the moving direction of the knob is the direction to increase the number of images adopted including objects corresponding to the knob. On the other hand, for example, the CPU 101 changes the content to an image illustrating a look of sorrow of the object corresponding to the knob when the moving direction of the knob is the direction to reduce the number of images adopted including objects corresponding to the knob.

Moreover, for example, a sound that is emitted from an output unit (not illustrated) included in the image processing apparatus 100 when the knob is moving may be changed according to the moving direction of the knob and the type of slider. In this case, for example, the CPU 101 emits a sound indicating the joy of the object corresponding to the knob from the output unit when the moving direction of the knob is the direction to increase the number of images adopted including objects corresponding to the knob. The sound indicating the joy is, for example, a lively bark of a dog. Moreover, if the object corresponding to the knob is an animal (the type of slider is one for changing the setting value of objects of “animals”), a dog bark is produced. If not, another sound is produced. In other words, it may be controlled in such a manner that a sound that is emitted while the knob for changing the setting value related to “people” is moving, and a sound that is emitted while the knob for changing the setting value related to “animals” is moving are different. On the other hand, for example, the CPU 101 causes the output unit to produce a sound indicating the sorrow of the object corresponding to the knob when the moving direction of the knob is the direction to reduce the number of images adopted including objects corresponding to the knob. The sound indicating the sorrow is, for example, a downhearted bark of a dog when the object corresponding to the knob is an animal.

Moreover, for example, the state of the knob may be changed according not only to the moving direction of the knob and the type of slider but to, for example, the position of the knob. For example, the CPU 101 moves the knob through a small arc when the knob moves in the direction to increase the number of images adopted including objects corresponding to the knob, between the position for setting the minimum value and the position for setting the intermediate value. Moreover, for example, the CPU 101 moves the knob through a large arc when the knob moves in the direction to increase the number of images adopted including objects corresponding to the knob, between the position for setting the intermediate value and the position for setting the maximum value. The degree of change in the state of the knob is changed according to the position of the knob also when the knob moves in the direction to increase the number of images adopted including objects corresponding to the knob.

Moreover, it is assumed in the above description that the slider to which the present disclosure is applied is the slider for changing the setting value related to the editing of an album. However, the embodiment is not limited to this mode. It may be, for example, a slider for changing the property (for example, brightness, lightness, contrast, or color) of image data according to the position of the knob, or a slider for adjusting the volume of the sound emitted from the output unit. In other words, the purpose of the slider to which the present disclosure is applied is not particularly limited.

Moreover, it is assumed in the above description that a plurality of sliders is displayed in parallel (simultaneously) on the same screen. However, the embodiment is not limited to this mode. For example, it may be a mode in which the slider for changing the setting value related to “people” and the slider for changing the setting value related to “animals” are displayed on different screens. Moreover, it may be, for example, a mode in which only the slider corresponding to the theme of an album is displayed on the editing screen. In this case, when the automatic layout process is executed again for editing, the process is performed on the basis of a setting value set by not the plurality of sliders but one slider.

Moreover, it is assumed in the above description that the sliders are displayed on the album editing screen. However, the embodiment is not limited to this mode. For example, the sliders may be displayed on the setting screen of FIG. 3 to execute the automatic layout process for creating layout information before editing on the basis of the setting values set by the sliders displayed on the setting screen.

The above-mentioned embodiment is also achieved by executing the following process, that is, a process of supplying software (a program) achieving the functions of the above-mentioned embodiment to a system or apparatus via a network or various storage media and causing a computer (such as a CPU or MPU) of the system or apparatus to read and execute the program. Moreover, the program may be executed by one computer, or executed by a plurality of computers in a ganged manner. Moreover, there is no need to achieve all the above processes by the software, and part or all of the processes may be achieved by hardware such as an ASIC. Moreover, also in terms of the CPU, not one CPU performs all the processes, but a plurality of CPUs may perform the processes in corporation with each other, as appropriate.

According to the present disclosure, it is possible to improve usability in the operation of moving a knob.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-016204, filed Jan. 31, 2017, which is hereby incorporated by reference herein in its entirety.

What is claimed is:

1. A control method executed by an image processing apparatus that stores a predetermined application program and displays a first slider including a first knob, and a second slider substantially parallel to the first slider, the second slider including a second knob, on a display unit by using the predetermined application program, the control method comprising:
moving the first knob along the first slider in accordance with a user's instruction; and
moving the second knob along the second slider in accordance with the user's instruction, wherein
a process based on at least one of a position of the first knob on the first slider and a position of the second knob on the second slider is executed, and
the amount of change in at least one element, other than a position in a predetermined direction, between a state of the first knob stopping at a stopping position on the first slider and a state of the first knob that has moved a predetermined distance in the predetermined direction from the stopping position is different from the amount of change in the at least one element between a state of the second knob stopping at a stopping position on the second slider and a state of the second knob that has moved the predetermined distance in the predetermined direction from the stopping position.

2. The control method according to claim 1, wherein the amount of change in at least one element, other than a position in the predetermined direction, between a state of the first knob stopping at a stopping position on the first slider and a state of the first knob that has moved a predetermined distance in a first direction from the stopping position is different from the amount of change in the element between a state of the first knob stopping at a stopping position on the first slider and a state of the first knob that has moved the predetermined distance from the stopping position in a second direction different from the first direction.

3. The control method according to claim 1, wherein the element is a position in a direction substantially orthogonal to the predetermined direction.

4. The control method according to claim 1, wherein the element is the amount of rotation of the knob.

5. The control method according to claim 1, wherein the element is the direction of rotation of the knob.

6. The control method according to claim 1, wherein the element is the content of an image placed on the knob.

7. The control method according to claim 1, wherein a track of the first knob is different from a track of the second knob.

8. The control method according to claim 1, wherein the first knob moves along an arc track along the first slider.

9. The control method according to claim 1, wherein the second knob moves along a straight track along the second slider.

10. The control method according to claim 1, wherein the first knob moves in a state of having rotated in any of the directions.

11. The control method according to claim 1, wherein a sound that is emitted from an output unit in a state where the first knob is moving is different from a sound that is emitted in a state where the second knob is moving.

12. The control method according to claim 1, wherein
the process based on at least one of the position of the first knob on the first slider and the position of the second knob on the second slider is a process of generating a layout image in which images represented by image data are placed in a template, on the basis of at least one of the position of the first knob on the first slider and the position of the second knob on the second slider,
a ratio of images including first objects corresponding to the first slider in images that are placed in the layout image in a state where the first knob has moved to a second position different from a first position on the first slider is increased as compared to a ratio of images including the first objects in images that are placed in the layout image in a state where the first knob has moved to the first position on the first slider, and
a ratio of images including second objects corresponding to the second slider in images that are placed in the layout image in a state where the second knob has moved to a fourth position different from a third position on the second slider is increased as compared to a ratio of images including the second objects in images that are placed in the layout image in a state where the second knob has moved to the third position on the second slider.

13. The control method according to claim 12, wherein
a ratio of images including the first objects in images that are placed in the layout image in a state where the first knob has moved to a fifth position different from the first and second positions on the first slider is increased as compared to the ratio of the images including the first objects in the images that are placed in the layout image in the state where the first knob has moved to the first position on the first slider,
the ratio of the images including the first objects in the images that are placed in the layout image in the state where the first knob has moved to the second position on the first slider is increased as compared to the ratio of the images including the first objects in the images that are placed in the layout image in the state where the first knob has moved to the fifth position on the first slider, and
the state of the first knob moving between the first position and the fifth position is different from the state of the first knob moving between the fifth position and the second position.

14. The control method according to claim 12, wherein an image related to the first object is placed on the first knob, and an image related to the second object is placed on the second knob.

15. The control method according to claim 14, wherein an orientation of the image related to the first object, the image being placed on the first knob on the move, is a direction in which the first knob moves.

16. The control method according to claim 12, wherein the first object is an object related to an animal.

17. The control method according to claim 12, wherein the second object is an object related to a person.

18. The control method according to claim 12, further comprising setting a mode of the layout image to be generated, wherein
the first object is an object corresponding to the set mode.

19. An image processing apparatus that displays a first slider including a first knob and a second slider substantially parallel to the first slider, the second slider including a second knob, on a display unit by using a predetermined application program, the image processing apparatus comprising:
a first movement control unit configured to move the first knob along the first slider in accordance with a user's instruction; and
a second movement control unit configured to move the second knob along the second slider in accordance with the user's instruction, wherein
a process based on at least one of a position of the first knob on the first slider and a position of the second knob on the second slider is executed, and
the amount of change in at least one element, other than a position in a predetermined direction, between a state of the first knob stopping at a stopping position on the first slider and a state of the first knob that has moved a predetermined distance in the predetermined direction from the stopping position is different from the amount of change in the element between a state of the second knob stopping at a stopping position on the second slider and a state of the second knob that has moved the predetermined distance in the predetermined direction from the stopping position.

20. A non-transitory computer readable medium storing a predetermined application program causing a computer of an image processing apparatus that displays a first slider including a first knob, and a second slider substantially parallel to the first slider, the second slider including a second knob, on a display unit by using the predetermined application program to execute:
moving the first knob along the first slider in accordance with a user's instruction; and
moving the second knob along the second slider in accordance with the user's instruction, wherein
a process based on at least one of a position of the first knob on the first slider and a position of the second knob on the second slider is executed, and
the amount of change in at least one element, other than a position in a predetermined direction, between a state of the first knob stopping at a stopping position on the first slider and a state of the first knob that has moved a predetermined distance in the predetermined direction from the stopping position is different from the amount of change in the element between a state of the second knob stopping at a stopping position on the second slider and a state of the second knob that has moved the predetermined distance in the predetermined direction from the stopping position.
